(19) United States
(12) Patent Application Publication
(10) Pub. No.: US 2024/0326954 A1
(43) Pub. Date: Oct. 3, 2024

(54) SWIVEL CONNECTORS FOR U-JOINTS AND PROCESSES FOR USING SAME

(71) Applicant: SOFEC, INC., HOUSTON, TX (US)

(72) Inventors: HAO Yu, Katy, TX (US); STEPHEN P. LINDBLADE, Waller, TX (US); MILES A. HOBDY, Richmond, TX (US)

(73) Assignee: SOFEC, INC., HOUSTON, TX (US)

(21) Appl. No.: 18/617,260

(22) Filed: Mar. 26, 2024

Related U.S. Application Data
(60) Provisional application No. 63/454,854, filed on Mar. 27, 2023.

(51) Int. Cl. B63B 21/00; F16C 11/04

(52) U.S. Cl. CPC B63B 21/00; F16C 11/04; B63B 2021/002; B63B 2021/003

(57) ABSTRACT

Mechanical joints and processes for using same. The joint can include a turntable having a first part and a second part rotatively connected to the first part and configured to rotate about a first axis. First and second supports can extend from opposing sides of a bore defined by the second part. The joint can include a body that includes first and second trunnions extending from a first pair of opposing sides thereof aligned along a second axis. A second pair of opposing sides of the body can define second and third bores aligned along a third axis. The joint can also include a pin configured to connect a member to the body such that when the member is connected to the body and the first and second trunnions are supported by the first and second supports, the member can rotate about the first, second, and third axes.

### CROSS-REFERENCE TO RELATED APPLICATION

This application claims priority to U.S. Provisional Patent Application No. 63/454,854, filed on Mar. 27, 2023, which is incorporated by reference herein.

### FIELD

Embodiments described generally relate to mechanical joints. More particularly, such embodiments relate to swivel connectors for u-joints for use in connecting a first member to a second member, e.g., for connecting a link arm to a floating body at an offshore site, and processes for using same.

### BACKGROUND

In the drilling, production, and transportation of offshore oil and gas, mooring systems have been used to connect floating production, storage, and offloading (FPSO) vessels, floating storage and offloading (FSO) vessels, barges, tankers, and other floating vessels to mooring structures. Some conventional mooring systems are permanent, meaning the connected vessel can be maintained on location even in 100-year survival environmental conditions. Other conventional mooring systems are disconnectable, allowing vessels to leave the field to avoid severe weather events and conditions such as harsh seas, typhoons, hurricanes, and icebergs. The process for connecting and disconnecting a vessel to the mooring structure via the conventional mooring systems can be time consuming and require complex systems and external intervention even in very limited sea states.

There is a need, therefore, for improved mechanical joints for use in connecting two bodies together, e.g., for use in mooring a vessel to a mooring structure at sea, and processes for using same.

### SUMMARY

Mechanical joints configured to provide an articulated connection between a first member and a second member and processes for using same are provided. In some embodiments, the mechanical joint can include a turntable that can include a first part configured to be fixedly connected to a first member and a second part rotatively coupled to the first part. The second part can be configured to rotate about a first axis with respect to the first part. The second part can define a bore at least partially therethrough. A first trunnion support and a second trunnion support can extend from opposing sides of an inner surface of the bore defined by the second part. The mechanical joint can also include a trunnion body that can define a first bore at least partially therethrough. The trunnion body can include a first trunnion disposed on and extending from a first exterior side and a second trunnion disposed on and extending from a second exterior side of a first pair of opposing sides of the trunnion body. The first and second trunnions can be aligned along a second axis and can be configured to be supported by the first and second trunnion supports, respectively. A first side of a second pair of opposing sides of the trunnion body can define a second bore extending from an inner surface of the first bore to an exterior of the first side of the second pair of opposing sides. A second side of the second pair of opposing sides of the trunnion body can define a third bore extending from the inner surface of the first bore at least partially through and toward an exterior of the second side of the second pair of opposing sides. The second bore and the third bore defined by the second pair of opposing sides of the trunnion body can be aligned along a third axis. The second axis and the third axis can be substantially orthogonal or substantially perpendicular with respect to one another. The second bore and the third bore defined by the second pair of opposing sides can be configured to receive a pin. The pin can be configured to connect the second member to the trunnion body such that when the second member is connected to the trunnion body and the first and second trunnions are supported by the first and second trunnion supports, the second member can be configured to at least partially rotate about the first, second, and third axes.

In some embodiments, a disconnectable yoke mooring system for mooring a vessel floating on a surface of a body of water can include a base structure, a first turntable, a yoke, a first link arm, a second link arm, a first mechanical joint, a second mechanical joint, a first lifting/lowering line, a second lifting/lowering line, a first lifting device, and a second lifting device. The base structure can be configured to be disposed on a seabed. The first turntable can be configured to be connected to the base structure such that the turntable can be rotatable with respect to the base structure about a vertical axis. The yoke can include a first end and a second end. The first end of the yoke can be configured to be connected to the turntable in a manner permitting the yoke to at least partially rotate about a longitudinal axis of the yoke and to at least partially rotate about a second axis that is substantially orthogonal or substantially perpendicular to the longitudinal axis of the yoke. The first link arm and the second link arm can each include a first end configured to be connected to the second end of the yoke. The first mechanical joint and the second mechanical joint can each be configured to connect a second end the first and second link arms, respectively, to the vessel. The first and second mechanical joints can each include a second turntable that can include a first part configured to be fixedly connected to the vessel and a second part rotatively connected to the first part. The second part can be configured to rotate about a first axis with respect to the first part. The second part can define a bore at least partially therethrough. A first trunnion support and a second trunnion support can extend from opposing sides of an inner surface of the bore defined by the second part. The first and second mechanical joints can also each include a trunnion body that can define a first bore at least partially therethrough. The trunnion body can include a first trunnion disposed on and extending from a first exterior side and a second trunnion disposed on and extending from a second exterior side of a first pair of opposing sides of the trunnion body. The first and second trunnions can be aligned along a second axis and configured to be supported by the first and second trunnion supports, respectively. A first side of a second pair of opposing sides of the trunnion body can define a second bore extending from an inner surface of the first bore to an exterior of the first side of the second pair of opposing sides. A second side of the second pair of opposing sides of the trunnion body can define a third bore extending from the inner surface of the first bore at least partially through and toward an exterior of the second side of the second pair of opposing sides. The second bore and the third bore defined by the second pair of opposing sides of the trunnion body can be aligned along a third axis. The second axis and the third axis can be substantially orthogonal or substantially perpendicular with respect to one another. The second bore and the third bore defined by the second pair of opposing sides of the trunnion body can be configured to receive a pin. The pin of the first mechanical joint can be configured to connect the second end of the first link arm and the pin of the second mechanical joint can be configured to connect the second end of the second link arm, respectively, to the trunnion body such that when the first and second link arms are connected to the vessel, the first and second link arms can be configured to at least partially rotate about the first, second, and third axes. The first lifting/lowering line and the second lifting/lowering line can each include a first end configured to be connected to the second ends of the first link arm and the second link arm, respectively. The first lifting device and the second lifting device can each be configured to be disposed on the vessel. The first lifting device and the second lifting device can be configured to be connected to a second end of the first lifting/lowering line and a second end of the second lifting/lowering line, respectively. When the first and second lifting devices are disposed on the vessel and connected to the second ends of the first and second lifting/lowering lines, respectively, and the first end of the first and second lifting/lowering lines are connected to the second ends of the first and second link arms, respectively, the first and second lifting devices can be configured to lift and lower the first and second link arms and the yoke.

In some embodiments, a process for disconnecting the first member from the second member connected to one another via a mechanical joint can include moving the second member and a trunnion body relative to the first member such that a first trunnion and a second trunnion can both separated and clear from a first trunnion support and a second trunnion support, respectively. The mechanical joint can include a turntable that can include a first part fixedly connected to the first member and a second part rotatively connected to the first part. The second part can be rotatable about a first axis with respect to the first part. The second part can define a bore at least partially therethrough. The first trunnion support and the second trunnion support can extend from opposing sides of an inner surface of the bore defined by the second part. The trunnion body can define a first bore at least partially therethrough. The trunnion body can include the first trunnion disposed on and extending from a first exterior side and the second trunnion disposed on and extending from a second exterior side of a first pair of opposing sides of the trunnion body. The first and second trunnions can be aligned along a second axis and supported by the first and second trunnion supports, respectively, prior to moving the second member and the trunnion body relative to the first member. A first side of a second pair of opposing sides of the trunnion body can define a second bore extending from an inner surface of the first bore to an exterior of the first side of the second pair of opposing sides. A second side of the second pair of opposing sides of the trunnion body can define a third bore extending from the inner surface of the first bore at least partially through and toward an exterior of the second side of the second pair of opposing sides. The second bore and the third bore defined by the second pair of opposing sides of the trunnion body can be aligned along a third axis. The second axis and the third axis can be substantially orthogonal or substantially perpendicular with respect to one another. A pin can be disposed through a bore defined by the second member and at least partially within the second bore and the third bore defined by the second pair of opposing sides that can connect the second member to the trunnion body. The second member can be at least partially rotatable about the first, second, and third axes. The process can also include rotating the second part of the turntable relative to the first part of the turntable such that the first trunnion and second trunnion are clear of the first trunnion support and the second trunnion support when viewed along the first axis. The process can also include moving the second member and the trunnion body such that the trunnion body moves past the first trunnion support and the second trunnion support when viewed along the first axis.

### BRIEF DESCRIPTION OF THE DRAWINGS

The various aspects and advantages of the preferred embodiment of the present invention will become apparent to those skilled in the art upon an understanding of the following detailed description of the invention, read in light of the accompanying drawings which are made a part of this specification. Like reference numerals shown throughout the drawings represent similar parts throughout the embodiments shown in the drawings.

FIG. 1 depicts an isometric cross-sectional view of an illustrative mechanical joint configured to provide an articulated connection between a first member and a second member, according to one or more embodiments described.

FIG. 2 depicts a cross-sectional elevation view of the mechanical joint shown in FIG. 1.

FIGS. 3 and 4 depict an isometric view and a plan view, respectively, of the mechanical joint shown in FIGS. 1 and 2.

FIGS. 5 and 6 depict isometric cross-sectional views of the mechanical joint shown in FIGS. 1-4 in a disconnected configuration, according to one or more embodiments described.

FIG. 7 depicts an isometric cross-sectional view of another illustrative mechanical joint configured to provide an articulated connection between a first member and a second member, according to one or more embodiments described.

FIG. 8 depicts a close-up view of a plain bearing arrangement shown in FIG. 7 that can be configured to handle horizontal loads, according to one or more embodiments described.

FIG. 9 depicts a cross-sectional elevation view of the mechanical joint shown in FIG. 7.

FIG. 10 depicts a perspective view of the mechanical joint shown in FIG. 7.

FIGS. 11 and 12 depict a top plan view and a bottom plan view, respectively, of the mechanical joint shown in FIG. 7.

FIG. 13 depicts an isometric cross-sectional view of another illustrative mechanical joint configured to provide an articulated connection between a first member and a second member, according to one or more embodiments described.

FIG. 14 depicts another isometric cross-sectional view of the mechanical joint shown in FIG. 13.

FIG. 15 depicts a close-up isometric view of a trunnion body in the mechanical joint shown in FIGS. 13 and 14 that includes first and second trunnion caps disposed on first and second trunnions, respectively, according to one or more embodiments described.

FIG. 16 depicts a close-up view of an illustrative sealing arrangement that can be disposed between ends of the first and second trunnion caps and the trunnion body shown in FIG. 15, according to one or more embodiments described.

FIG. 17 depicts an illustrative connector arrangement that can be used to connect the first and second trunnion caps to the first and second trunnions, respectively, shown in FIG. 15, according to one or more embodiments described.

FIG. 18 depicts a close-up cross-sectional view of a plate connected to the trunnion body, shown in FIG. 15, according to one or more embodiments described.

FIG. 19 depicts a close-up cross-sectional view of a sealing arrangement that can be located between an inner surface of a bore defined by a trunnion body and a second member connected thereto, according to one or more embodiments described.

FIG. 20 depicts an isometric cross-sectional view showing a lower contact surface for a guide body shown in FIGS. 13 and 14 that can be disposed within the mechanical joint, according to one or more embodiments described.

FIG. 21 depicts a close-up cross-sectional view of a bearing shown in FIGS. 13 and 14, according to one or more embodiments described.

FIG. 22 depicts a close-up view of an upper retainer body that can be configured to secure a guide member shown in FIGS. 13 and 14 against the lower contact surface depicted in FIG. 20, according to one or more embodiments described.

FIG. 23 depicts an isometric view of an illustrative mooring system for mooring a vessel floating on a surface of a body of water that can include one of the mechanical joints described above with reference to FIGS. 1-22, according to one or more embodiments described.

FIG. 24 depict a side elevation partial cross-sectional view of an illustrative lifting arrangement that includes a first lifting device and second lifting device that can be used to connect and disconnect one of the mechanical joints shown in FIGS. 1-22, according to one or more embodiments described.

### DETAILED DESCRIPTION

A detailed description will now be provided. Each of the appended claims defines a separate invention, which for infringement purposes is recognized as including equivalents to the various elements or limitations specified in the claims. Depending on the context, all references to the “invention”, in some cases, refer to certain specific or preferred embodiments only. In other cases, references to the “invention” refer to subject matter recited in one or more, but not necessarily all, of the claims. It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the figures provided herein. This repetition is for the purpose of simplicity and clarity and does not in itself dictate a relationship between the various exemplary embodiments and/or configurations discussed in the Figures. Moreover, the formation of a first feature over or on a second feature in the description that follows includes embodiments in which the first and second features are formed in direct contact and also includes embodiments in which additional features are formed interposing the first and second features, such that the first and second features are not in direct contact. The exemplary embodiments presented below may be combined in any combination of ways, i.e., any element from one exemplary embodiment may be used in any other exemplary embodiment, without departing from the scope of the disclosure. The figures are not necessarily drawn to scale and certain features and certain views of the figures can be shown exaggerated in scale or in schematic for clarity and/or conciseness.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Also, the naming convention used herein is not intended to distinguish between components that differ in name but not function. Furthermore, in the following discussion and in the claims, the terms “including” and “comprising” are used in an open-ended fashion, and thus should be interpreted to mean “including, but not limited to.”

All numerical values in this disclosure are exact or approximate values (“about”) unless otherwise specifically stated. Accordingly, various embodiments of the disclosure may deviate from the numbers, values, and ranges disclosed herein without departing from the intended scope.

Further, the term “or” is intended to encompass both exclusive and inclusive cases, i.e., “A or B” is intended to be synonymous with “at least one of A and B,” unless otherwise expressly specified herein. The indefinite articles “a” and “an” refer to both singular forms (i.e., “one”) and plural referents (i.e., one or more) unless the context clearly dictates otherwise. The terms “up” and “down”; “upward” and “downward”; “upper” and “lower”; “upwardly” and “downwardly”; “above” and “below”; and other like terms used herein refer to relative positions to one another and are not intended to denote a particular spatial orientation since the apparatus and methods of using the same may be equally effective at various angles or orientations.

It should also be understood that the phrases “disposed therein”, “disposed within” and other similar phrases, when describing a component, e.g., an arm or ball, describe the component as being partially disposed therein/within or completely disposed therein/within. For example, if the component is a ball disposed on the end of an arm that can be disposed within a socket, the phrase “the ball can be disposed within the socket” means the ball can be disposed partially within the socket or completely within the socket.

The terms “rotate”, “rotation”, “rotatable”, and “rotating” mean unlimited or partial rotation of a body about an axis of rotation.

The terms “orthogonal” and “orthogonally” refer to two lines or vectors that are not coplanar and therefore do not intersect but can appear to be perpendicular when viewed from a particular angle. For example, a first line being orthogonal to a second line, the first line can lie in a first plane and the second line can lie in a second plane, where the first and second planes are parallel with respect to one another and the first line and the second line are oriented at 90 degrees with respect to one another when viewed along an axis that is normal to the first and second planes. Further is should be understood that the term “substantially” when used in the context of “substantially orthogonal” means the first and second line are orientated at angles of about 80 degrees, about 83 degrees, about 85 degrees, about 87 degrees, or about 89 degrees to, about 91 degrees, about 93 degrees, about 95 degrees, about 97 degrees, or about 100 degrees with respect to one another when viewed along an axis that is normal to the first and second planes.

The terms “perpendicular” and “perpendicularly”, as used herein, refer to two lines or vectors that are coplanar and, therefore, do intersect one another at a 90 degree angle. Further, the term “substantially” when used in the context of “substantially perpendicular” means a first line and a second line are orientated at angles of about 80 degrees, about 83 degrees, about 85 degrees, about 87 degrees, or about 89 degrees to, about 91 degrees, about 93 degrees, about 95 degrees, about 97 degrees, or about 100 degrees with respect to one another. Further, the term “substantially” when used in the context of “substantially parallel” means an axis and a plane (e.g., the surface of a body of water) are orientated at angles of about 160 degrees, about 165 degrees, about 170 degrees, about 175 degrees, or about 180, or about 185 degrees, or about 190 degrees, or about 195 degrees, or about 200 degrees with respect to one another.

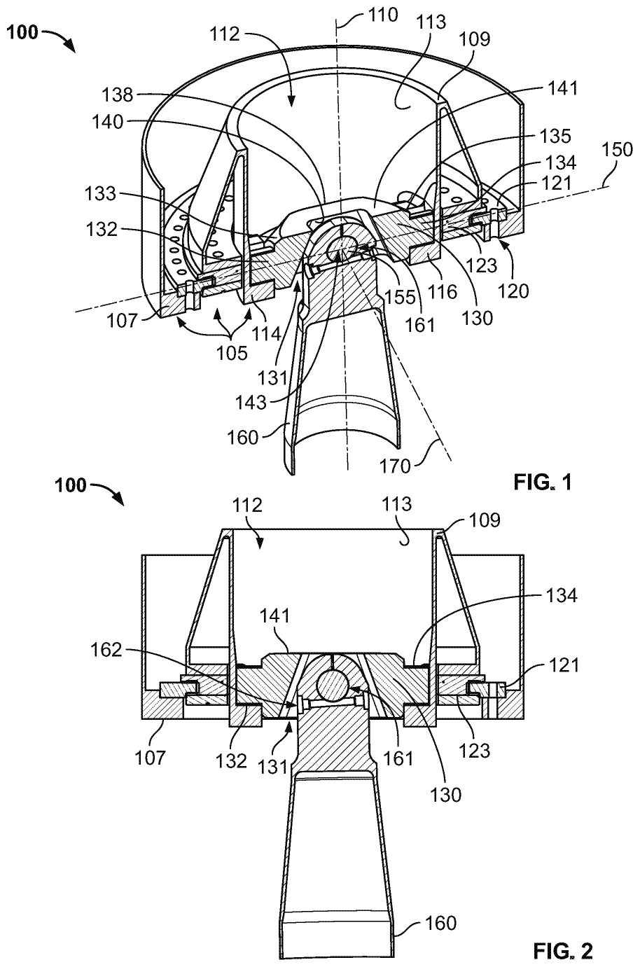

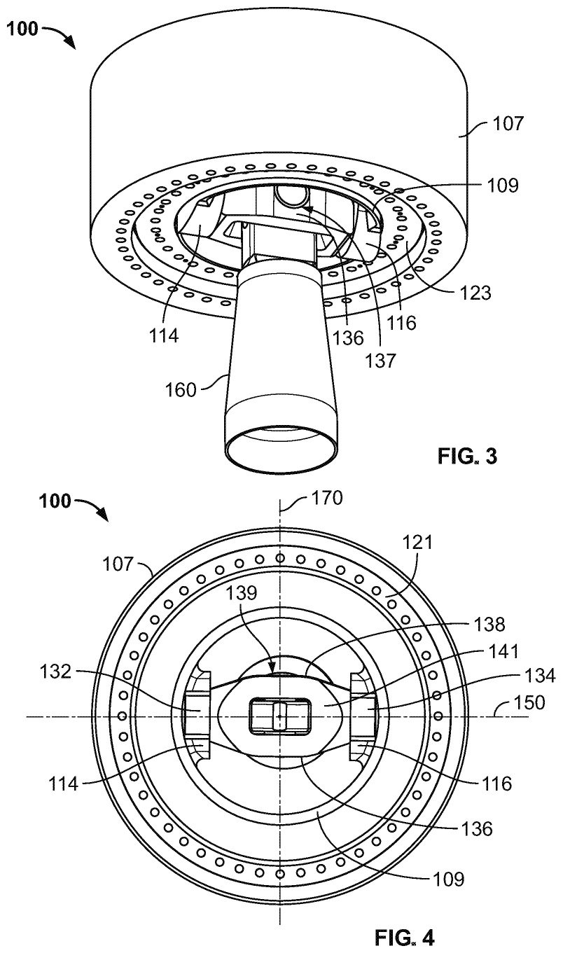

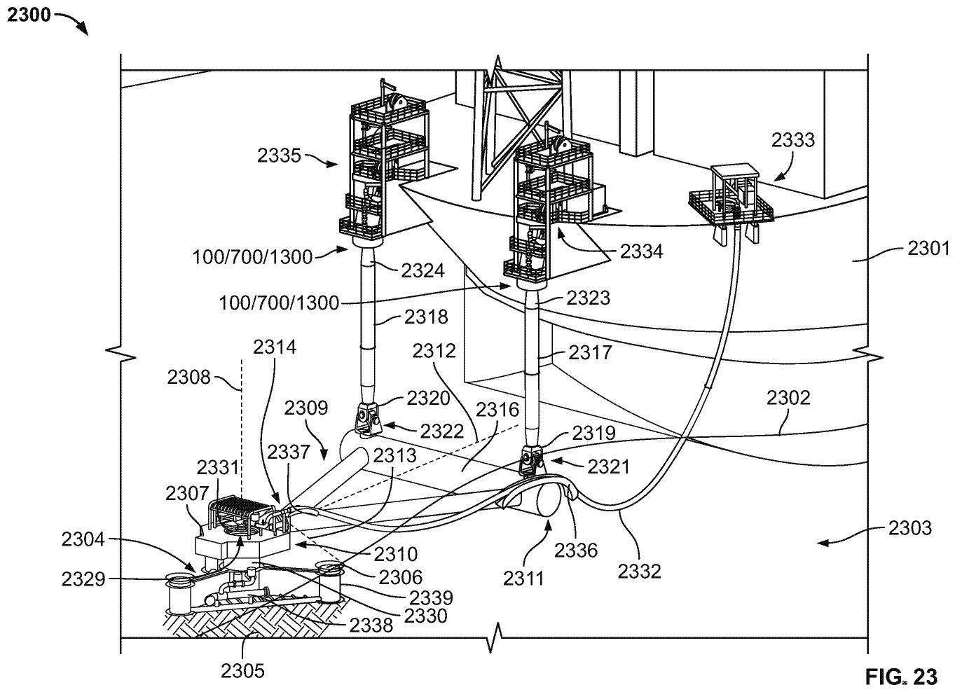

FIG. 1 depicts an isometric cross-sectional view of an illustrative mechanical joint 100 configured to provide an articulated connection between a first member, e.g., a vessel (see FIG. 23), and a second member 160, according to one or more embodiments. FIG. 2 depicts a cross-sectional elevation view of the mechanical joint 100 shown in FIG. 1. FIGS. 3 and 4 depict an isometric view and a plan view, respectively, of the mechanical joint 100 shown in FIGS. 1 and 2. Continuing with reference to FIGS. 1-4, the mechanical joint 100 can include a turntable 105 that can include a first part 107 configured to be fixedly connected to the first member, e.g., a vessel, and a second part 109 rotatively connected to the first part 107. A trunnion body 130 can be rotatively connected to the second part 109 and can be configured to receive a pin 155 that can connect a second member 160 to the trunnion body 130, according to one or more embodiments. FIG. 2 depicts a cross-sectional elevation view of the mechanical joint 100 shown in FIG. 1. FIGS. 3 and 4 depict an isometric view and a plan view, respectively, of the mechanical joint 100 shown in FIGS. 1 and 2.

The second part 109 of the turntable 105 can be configured to rotate about a first axis 110 with respect to the first part 107. The second part 109 of the turntable 105 can define a bore 112 at least partially therethrough. The second part 109 of the turntable 105 can include a first trunnion support 114 and a second trunnion support 116 that can extend from opposing sides of an inner surface 113 the bore 112 defined by the second part 109 of the turntable 105.

In some embodiments, the first part 107 of the turntable 105 can be fixedly connected to the first member, e.g., a vessel (see FIG. 23), and the second part 109 of the turntable 105 can be rotatively connected to the first part 107 via one or more bearings 120. As shown, the bearing 120 can be or can include a three-row roller bearing that can include a first part 121 that can be connected to or integrated with the first part 107 of the turntable 105 and a second part 123 that can be connected to or integrated with the second part 109 of the turntable 105. The bearing 120 can be configured to support an axial load, a horizontal load, and an overturning moment load. Three-row roller bearings are well-known to those having ordinary skill in the art. Suitable three-row roller bearings can include those described in U.S. Pat. Nos. 10,046,834; 10,183,727; 10,538,291; and 11,319,030. Other suitable bearings that can be used as the bearing 120 can include those described in U.S. Pat. No. 8,950,349.

The trunnion body 130 can define a first bore 131 at least partially therethrough. The trunnion body 130 can include a first trunnion 132 disposed on and extending from a side or first exterior side 133 and a second trunnion 134 disposed on and extending from a second side or second exterior side 135 of the trunnion body 130. The first exterior side 133 and the second exterior side 135 can be referred to as a first pair of opposing sides of the trunnion body 130. The first and second trunnions 132, 134 can be configured to be supported by the first and second trunnion supports 114, 116, respectively. When the first and second trunnions 132, 134 are supported by the first and second trunnion supports 114, 116, the first and second trunnions 132, 134 and the first and second trunnion supports 114, 116 can be aligned along a second axis 150.

In some embodiments, the first and second trunnion supports 114, 116 can define a U-shaped saddle structure that can include an open mouth or top. In other embodiments, the first and second trunnion supports 114, 116 can define a semi-circular shaped saddle structure that can include an open mouth or top. In some embodiments, the first and second trunnion supports 114, 116 can be configured to receive and support the first and second trunnions 132, 134 within the U-shaped and/or semi-circular shaped saddle structures of the first and second trunnion supports 114, 116. In some embodiments, the open mouth or top of the U-shaped and/or semi-circular shaped saddle structures of the first and second trunnion supports 114, 116 can remain open as shown or can be configured to receive a cap or other member configured to close and retain the first and second trunnions 132, 134 therein. When the first and second trunnions 132, 134 are supported by the first and second trunnion supports 114, 116, the trunnion body 130 can be configured to at least partially rotate about the second axis 150.

A side or first side 136 and a side or second side 138 of the trunnion body 130 can define a second bore 137 and a third bore 139, respectively. The first side 136 and the second side 138 of the trunnion body 130 can be referred to as a second pair of opposing sides of the trunnion body 130. The second bore 137 can extend from an inner surface 140 of the first bore 131 defined by the trunnion body 130 to an exterior of the first side 136 of the second pair of opposing sides of the trunnion body 130. The third bore 139 can extend from the inner surface 140 of the first bore 131 defined by the trunnion body 130 at least partially through and toward an exterior of the second side 138 of the second pair of opposing sides of the trunnion body 130. In some embodiments, the third bore 139 can extend from the inner surface 140 of the first bore 131 defined by the trunnion body 130 to an exterior of the second side 138 of the second pair of opposing sides of the trunnion body 130. The second bore 137 and the third bore 139 defined by the second pair of opposing sides of the trunnion body 130 can be aligned along a third axis 170.

The second bore 137 and the third bore 139 defined by the second pair of opposing sides of the trunnion body 130 can be configured to receive a pin 155. In some embodiments, the pin 155 can be an elongated member that can include a substantially cylindrical body. The second member 160 can define a bore or first bore 161 that can also be configured to receive the pin 155. As such, the pin 155 can be configured to connect the second body 160 to the trunnion body 130 via the pin 155 by disposing or otherwise locating the pin 155 within the bore 161 defined by the second member 160 and at least partially within the second bore 137 and at least partially within the third bore 139 defined by the second pair of opposing sides of the trunnion body 130. As such, the second and third bores 137, 139 defined by the second pair of opposing sides of the trunnion body 130 and the pin 155, when connected to one another, can be aligned along the third axis 170. In some embodiments, as shown, the second axis 150 and the third axis 170 can be substantially perpendicular with respect to one another. In other embodiments, not shown, the second axis 150 and the third axis 170 can be substantially orthogonal with respect to one another.

In some embodiments, the pin 155 and/or the second member 160, when connected to the second part 109 of the turntable 105 via the trunnion body 130, can be configured to at least partially rotate about third axis 170. As such, when the second member 160 is connected to the first member, e.g., a vessel (see FIG. 23), via the turntable 105, the trunnion body 130, and the pin 155, the second member 160 can be configured to at least partially rotate about the first axis 110, the second axis 150, and the third axis 170. In some embodiments, the first axis 110 can intersect the second axis 150 and the third axis 170 at an intersection point 143. As such, the trunnion body 130, the second member 160, and the pin 155 connecting the second member 160 to the trunnion body 130 can be configured to rotate partially around or completely around the first axis 110.

In some embodiments, the second axis 150, the third axis 170, and the bearing 120 can be substantially co-planar with respect to one another. For example, in some embodiments, at least a portion of the bearing 120, at least a portion of the first and second trunnions 132, 134, and at least a portion of the pin 155 can be substantially co-planar with respect to one another. In other embodiments, the bearing 120 and one of the second axis 150 and the third axis 170 can be substantially co-planar with respect to one another and one of the second axis 150 and the third axis 170 can be located outside the plane the bearing 120 and the other one of the second axis 150 and the third axis 170 are located in. In some embodiments, the second and third bores 137, 139 defined by the second pair of opposing sides of the trunnion body 130 can be located away from or below the axis 150 the first and second trunnions 132, 134 can be aligned on such that the second and third bores 137, 139 can be aligned along another axis that can be orthogonal with respect to the second axis 150. In still other embodiments, the bearing 120, the first and second trunnions 132, 134, and the second and third bores 137, 139 can each be configured to lie in different planes with respect to one another.

In some embodiments, an upper surface 141 of the trunnion body 130 can include one or more connector structures (not shown). In some embodiments, the upper surface 141 can include a connector structure that can define an aperture, opening, or bore and/or can be or include a protrusion, such as a male type connector or any other connector that can be configured to connect to a lifting/lowering line. In some embodiments, the connector structure can be or can include, but is not limited to, a padeye, a clevis, a trunnion, a lifting lug, or the like, disposed on the upper surface 141 of the trunnion body 130. The lifting/lowering line, when attached to the connector structure, can be used to raise and lower the trunnion body 130 and the second member 160 (when connected thereto) to move the first and second trunnions 132, 134 onto and off of the trunnion supports 114, 116. The lifting/lowering line can be or can include, but is not limited to, a synthetic rope, a metal or wire rope, a chain, a cable, any other suitable elongated member, or any combination thereof. In some embodiments, the connector structure can be or can include the connector structures described in U.S. Patent Application Publication Nos. 2023/0124086 and 2023/0150614.

In some embodiments, the second member 160 can define a second bore 162 at least partially therethrough. In such embodiment, the second bore 162 and the first bore 161 can partially intersect one another. In some embodiments, a central axis through the first bore 161 and a central axis through the second bore 162 defined by the second member 160 can be substantially orthogonal with respect to one another. The second bore 162 defined by the second member 160 can be configured to receive a wedge (not shown) that can include an engagement surface formed on a portion of an external surface of the wedge between a first end and a second end thereof. In such embodiment, the pin 155 can also include an engagement surface formed on a portion of an external surface of the pin 155. The partial intersection between the first bore 161 and the second bore 162 can be configured to permit the engagement surface of the wedge to contact the engagement surface of the pin 155 when the pin 155 and the wedge are disposed within the first bore 161 and the second bore 162, respectively. In such embodiment, the contact between the pin 155 and the wedge can restrict or prevent relative rotation between the pin 155 and the second member 160.

When the second member 160 defines the second bore 162 that can be configured to receive the wedge, the engagement surface formed on the external surface of the pin 155 can be oriented substantially perpendicular to a longitudinal axis of the pin 155. In some embodiments, the engagement surface of the pin 155 can be defined by a groove, channel, depression, recess, or any other shape. In some embodiments, the engagement surface of the pin 155 can be flat. In some embodiments, the engagement surface of the pin 155 can be located or otherwise positioned at a midpoint of the pin 155. In other embodiments, however, the engagement surface of the pin 155 can be located or otherwise positioned at a location that can be offset from the midpoint. In some embodiments, the pin 155 can include two or more engagement surfaces and, in such embodiment, the two or more engagement surfaces can be equally spaced or non-equally spaced apart from one another between the first and second ends of the pin 155. In some embodiments, when the pin 155 includes two or more engagement surfaces, the second member 160 can define two or more “second” bores at least partially therethrough that can each be configured to receive a wedge therein.

In some embodiments, the engagement surface of the wedge can be defined by a groove, channel, depression, recess, or any other shape. In other embodiments, the engagement surface of the wedge can be flat. In some embodiments, a thickness of a first end of the wedge can be less than a thickness of a second end of the wedge such that the engagement surface can be tapered along a longitudinal axis of the wedge. In some embodiments, the of the wedge can be configured as having a generally cylindrical or cuboidal body, a generally cylindrical or cuboidal body with one or two generally frusto-conical ends, or a generally cylindrical or cuboidal body with one or two generally frusto-pyramidal ends, or a combination thereof. As such, in some embodiments, the wedge can include a taper or chamfer on one or both ends thereof that can facilitate insertion of the wedge into the second bore 162 and extraction of the wedge out of the second bore 162. In some embodiments, the wedge can define a threaded bore at one or both ends thereof to facilitate the insertion, preloading, retention, and/or extraction of the wedge within the second bore 162. In some embodiments, the wedge can define a single threaded bore that can span the entire length of the wedge.

In some embodiments, the wedge can be positioned within the second bore 162 with a sufficient amount of axial force applied to the first end of the wedge, the second end of the wedge, or both ends of the wedge to force or otherwise urge the engagement surface of the wedge into contact with the engagement surface of the pin 155 and to secure the pin 155 and the wedge within the second bore 162. The force can be applied via any number of ways including a tension or jack screw mechanism, a hydraulic cylinder, impact force, or other similar means. It has been found that by applying a sufficient amount of axial force to the wedge, the need for a sleeve, shim, or other bushing between an outer surface of the pin 155 and an inner surface of the first bore 161 can be eliminated. As used herein, the term “bushing” refers to any sleeve, shim, liner, inlay, pad, or any other structure configured to reduce friction and/or wear between an outer surface of a pin and an inner surface of a bore the pin is at least partially disposed within. Said another way, in some embodiments, by applying a sufficient amount of axial force to the wedge the outer surface of the first pin 155 and an inner surface of the first bore 161 can be in direct contact with one another. In other embodiments, however, a bushing can be disposed between the outer surface of the pin 155 and the inner surface of the first bore 161 of the second member 160. When the second member 160 includes the second bore 162 configured to receive the wedge, such configuration can include those described in U.S. Patent Application Publication No. 2023/0151846.

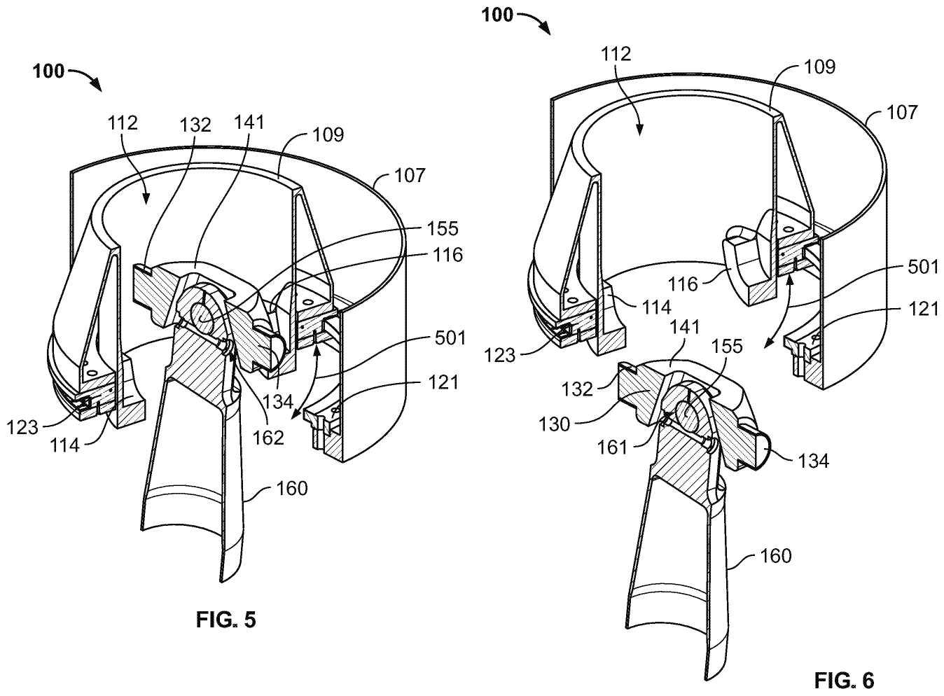

FIGS. 5 and 6 depict isometric cross-sectional views of the mechanical joint 100 shown in FIGS. 1-4 in a disconnected configuration, according to one or more embodiments. As shown in FIGS. 5 and 6, the trunnion body 130 can be configured to be disconnected from the second part 109 of the turntable 105. In some embodiments, the trunnion body 130 can be moved away from the first and second trunnion supports 114, 116 such that the first and second trunnions 132, 134 can be moved off of and out of the trunnion support structures 114, 116. For example, when the trunnion support structures 114, 116 define U-shaped saddle structures, the trunnion body 130 can be moved sufficiently far enough away from the trunnion support structures 114, 116 such that the first and second trunnions 132, 134 are completely outside of the U-shaped saddle structures.

The trunnion body 130, along with the pin 155 and the second member 160 can be moved away from the first and second trunnion supports 114, 116 via any suitable lifting device. In some embodiments, the lifting device can be disposed on the first member, e.g., a vessel (see FIG. 23). The lifting device can be or can include, but is not limited to, a chain jack, a strand jack, a linear winch, a rotary winch, other similar device, or combinations thereof. The lifting device can be electrically driven, hydraulically driven, pneumatically driven, hydrocarbon combustion driven, or a combination thereof. In some embodiments, the lifting device can be disposed on the first member and a lifting/lowering line can be routed through at least one sheave. The at least one sheave can provide flexibility as to where the lifting device can be disposed on the first member. In some embodiments, suitable lifting devices and lifting arrangements can include those described in U.S. Patent Application Publication No. 2023/0150614.

When the trunnion body 130 has been moved sufficiently far enough away from the trunnion support structures 114, 116 such that the first and second trunnions 132, 134 are completely outside of the trunnion support structures 114, 116, the second part 109 of the turntable 105 can be rotated (arrow 501) with respect to the first part 107 of the turntable 105. For example, in some embodiments, the second part 109 can be rotated about 70 degrees to about 110 degrees with respect to the trunnion body 130. With the trunnion body 130 moved sufficiently far enough away from the trunnion support structures 114, 116 and the second part 109 of the turntable 105 rotated a sufficient amount, the trunnion body 130, the pin 155, and the second member 160 can be lowered or otherwise moved through the bore 112 defined by the second part 109 of the turntable 105 to completely separate and disconnect the first member from the second member 160.

In some embodiments, the second part 109 of the turntable 105 can be rotated with respect to the first part 107 of the turntable 105 via one or more drive mechanisms. The drive mechanism can be electrically driven, hydraulically driven, pneumatically driven, hydrocarbon combustion driven, or any combination thereof. In some embodiments, not shown, the drive mechanism can be configured to rotate the second part 109 relative to the first part 107 in a manner similar to that utilized on the disconnectable turret mooring system disclosed in US Patent Application Publication No. 2009/0104827. In other embodiments, not shown, the drive mechanism can include a hydraulic, electric, or pneumatic cylinder fixed to the first part 107 or the first member at a first end thereof and to the second part 109 at a second end thereof. In some embodiments, the second end of the hydraulic, electric, or pneumatic cylinder can be releasably attached to the second part 109. When the second end of the hydraulic, electric, or pneumatic cylinder is attached to the second part 109, the hydraulic, electric, or pneumatic cylinder can be activated to extend the piston rod therefrom to cause the second part 109 of the turntable 105 to rotate with respect to the first part 107 of the turntable 105.

The trunnion body 130 can be reconnected to the turntable 105 by carrying out the disconnection sequence in reverse order. More particularly, the lifting device(s) can raise or otherwise move the trunnion body 130 into the bore 112 defined by the second part 109 of the turntable 105 a sufficient amount such that the second part 109 of the turntable 105 can be rotated (arrow 501) via the drive mechanism to align the trunnion support structures 114, 116 with the first and second trunnions 132, 134. The lifting device can then lower or otherwise move the trunnion body 130 toward the trunnion support structures 114, 116 such that the first and second trunnions 132, 134 can engage with and be supported by the trunnion support structures 114, 116.

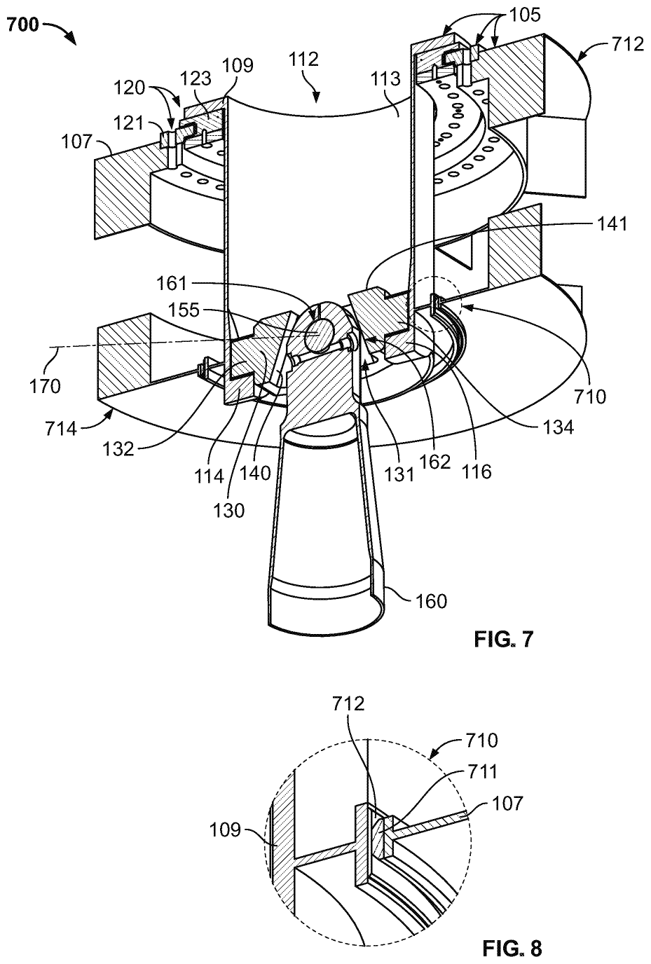

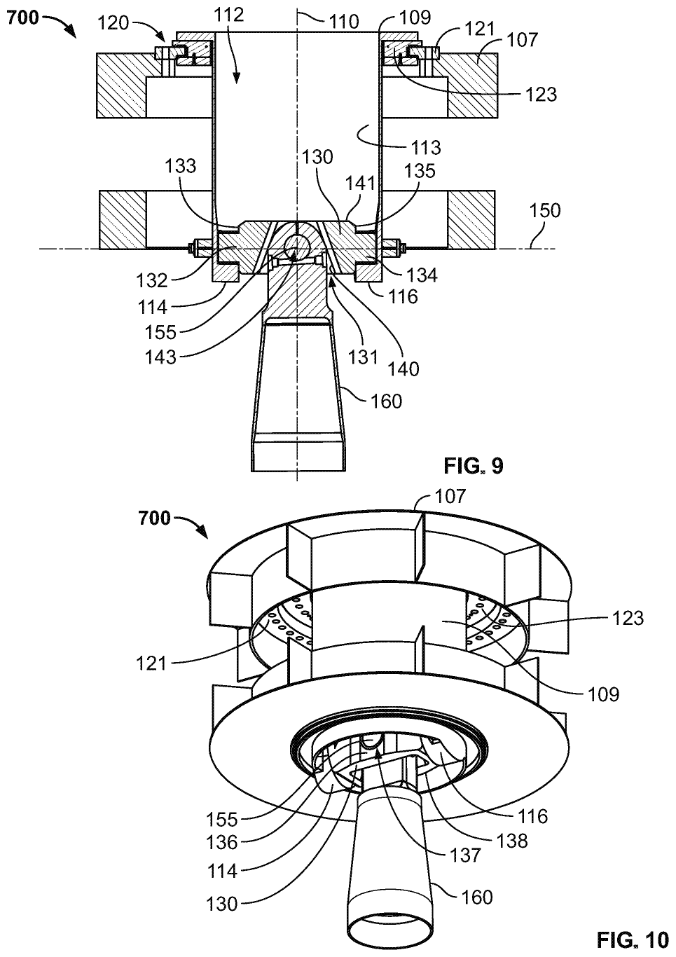

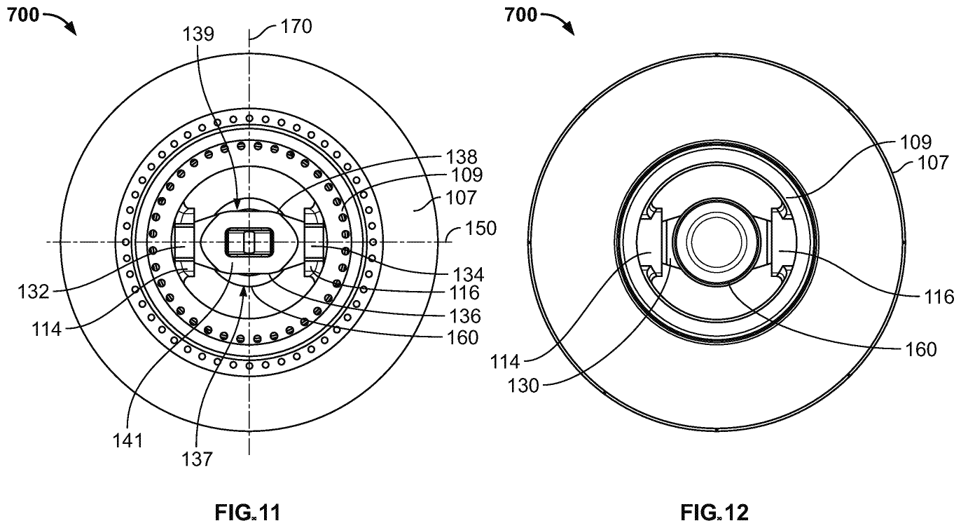

FIG. 7 depicts an isometric cross-sectional view of another illustrative mechanical joint 700 configured to provide an articulated connection between the first member, e.g., a vessel (see FIG. 23) and the second member 160, according to one or more embodiments. FIG. 8 depicts a close-up view of a plain bearing arrangement 710 shown in FIG. 7 that can be configured to handle radial or horizontal loads, according to one or more embodiments. FIG. 9 depicts a cross-sectional elevation view of the mechanical joint 700 shown in FIG. 7. FIG. 10 depicts a perspective view of the mechanical joint 700 shown in FIG. 7. FIGS. 11 and 12 depict a top plan view and a bottom plan view, respectively, of the mechanical joint shown in FIG. 7. The mechanical joint 700 can include the turntable 105 that can include the first part 107 configured to be fixedly connected to the first member, e.g., the vessel, and the second part 109 rotatively connected to the first part 107. The mechanical joint 700 can also include the trunnion body 130 that can be rotatively connected to the second part 109 and can be configured to receive the pin 155 that can connect a second member 160 to the trunnion body 130, according to one or more embodiments.

As described above with reference to FIGS. 1-4, the second part 109 of the turntable 105 can be configured to rotate about the first axis 110 with respect to the first part 107. In some embodiments, the second part 109 of the turntable 105 can be rotated with respect to the first part 107 of the turntable 105 via one or more drive mechanisms, as described above. The second part 109 of the turntable 105 can define the bore 112 at least partially therethrough. The second part 109 of the turntable 105 can include the first trunnion support 114 and the second trunnion support 116 that can extend from opposing sides of the inner surface 113 the bore 112 defined by the second part 109 of the turntable 105.

In some embodiments, the first part 107 of the turntable 105 can be fixedly connected to the first member, e.g., a vessel (see FIG. 23), and the second part 109 of the turntable 105 can be rotatively connected to the first part 107 via one or more bearings 120. As shown, the bearing 120 can be or can include a three-row roller bearing that can include a first part 121 that can be connected to or integrated with the first part 107 of the turntable 105 and a second part 123 that can be connected to or integrated with the second part 109 of the turntable 105. The bearing 120 can be configured to support an axial load, a horizontal load, and an overturning moment load. Three-row roller bearings are well-known to those having ordinary skill in the art. Suitable three-row roller bearings can include those described in U.S. Pat. Nos. 5,893,784; 10,046,834; 10,183,727; 10,538,291; and 11,319,030. Other suitable bearings that can be used as the bearing 120 can include those described in U.S. Pat. Nos. 8,671,864 and 8,950,349.

One difference between the mechanical joint 100 and the mechanical joint 700 is that the mechanical joint 700 includes at least one bearing 710 in addition to the bearing 120. In such embodiment, the bearing 120 can be referred to as a first bearing and the bearing 710 can be referred to as a second bearing. Another difference between the mechanical joint 100 and the mechanical joint 700 is that the bearing 120 is disposed toward a first or “top” end 712 of the mechanical joint 700 and the bearing 710 is disposed toward a second or “bottom” end 714 of the mechanical joint 700. As such, the bearing 120 in the mechanical joint 700 can be longitudinally located or otherwise displaced along axis 110 away from the trunnion body 130. In some embodiments, the bearing 710 can be a plain bearing configured to handle radial or horizontal loads. The configuration of the mechanical joint 700, as compared to the mechanical joint 100, can reduce or minimize the size of and the loading on the bearing 120. Since primarily or only horizontal loading is applied to the bearing 710, the torque due to friction generated by the bearing 710 can be acceptable for the design tolerances of the mechanical joint 700. The bearing 120 that can support the vertical or axial load and the moment and horizontal loads can be minimized thereby reducing the size of the mechanical joint 700.

The bearing 710 can include a first contact surface 711 that can be disposed on the first part 107 of the turntable 105 and a second contact surface 712 that can be disposed on the second part 109 of the turntable 105. The first contact surface 711 and the second contact surface 712 can be configured to engage with one another and the second contact surface 712 can be configured to move with respect to the first contact surface 711. In some embodiments, the first contact surface 711 can be composed of a self-lubricated composite material and the second contact surface 712 can be composed of a metal or metal alloy, e.g., stainless steel. In other embodiments, the first contact surface 711 can be composed of a metal or metal alloy, e.g., stainless steel, and the second contact surface 712 can be composed of a self-lubricated composite material. In still other embodiments, the first contact surface 711 and the second contact surface 712 can each be composed of a self-lubricated composite material. In some embodiments, a suitable self-lubricated composite material can include ORKOT® available from Trelleborg.

The trunnion body 130 can define the first bore 131 at least partially therethrough and can include the first trunnion 132 disposed on and extending from the first side or first exterior side 133 and the second trunnion 134 disposed on and extending from the second side or second exterior side 135 of the trunnion body 130, as described above with reference to FIGS. 1-4. As such, the trunnion body 130, when rotatively connected to the second part 109 of the turntable via the first and second trunnions 132, 134 and the first and second trunnion supports 114, 116, respectively, can be configured to at least partially rotate about the second axis 150. In some embodiments, the upper surface 141 of the trunnion body 130 can include one or more connector structures (not shown), as described above with reference to FIGS. 1-4, that can be configured to be connected to the lifting/lowering line.

The side or first side 136 and the side or second side 138 of the trunnion body 130 can define the second bore 137 and the third bore 139 (not visible but see FIG. 11), respectively. The first side 136 and the second side 138 of the trunnion body 130 can be referred to as a second pair of opposing sides of the trunnion body 130. The second bore 137 can extend from the inner surface 140 of the first bore 131 defined by the trunnion body 130 to an exterior of the first side 136 of the second pair of opposing sides of the trunnion body 130. The third bore 139 can extend from the inner surface 140 of the first bore 131 defined by the trunnion body 130 at least partially through and toward an exterior of the second side 138 of the second pair of opposing sides of the trunnion body 130. In some embodiments, the third bore 139 can extend from the inner surface 140 of the first bore 131 defined by the trunnion body 130 to an exterior of the second side 138 of the second pair of opposing sides of the trunnion body 130. The second bore 137 and the third bore 139 defined by the second pair of opposing sides of the trunnion body 130 can be aligned along the third axis 170.

The second bore 137 and the third bore 139 defined by the second pair of opposing sides 136, 138 of the trunnion body 130 can be configured to receive the pin 155 and the second member 160 can define the bore or first bore 161 that can also be configured to receive the pin 155, as described above with reference to FIGS. 1-4. As such, the second and third bores 137, 139 defined by the second pair of opposing sides 136, 138 of the trunnion body 130 and the pin 155, when connected to one another, can be aligned along the third axis 170. In some embodiments, as shown in FIG. 11, the second axis 150 and the third axis 170 can be substantially perpendicular with respect to one another. In other embodiments, not shown, the second axis 150 and the third axis 170 can be substantially orthogonal with respect to one another.

In some embodiments, the pin 155 and/or the second member 160, when connected to the second part 109 of the turntable 105 via the trunnion body 130, can be configured to at least partially rotate about the third axis 170. As such, when the second member 160 is connected to the first member, e.g., a vessel (see FIG. 23), via the turntable 105, the trunnion body 130, and the pin 155, the second member 160 can be configured to at least partially rotate about the first axis 110, the second axis 150, and the third axis 170. In some embodiments, the first axis 110 can intersect the second axis 150 and the third axis 170 at an intersection point, similar to the intersection point 143 shown in FIG. 1. As such, the trunnion body 130 and the second member 160 and the pin 155 connecting the second member 160 to the trunnion body 130 can be configured to rotate partially around or completely around the first axis 110. In some embodiments, the second axis 150, the third axis 170, and the bearing 710 can be substantially co-planar with respect to one another. For example, in some embodiments, at least a portion of the bearing 710, at least a portion of the first and second trunnions 132, 134, and at least a portion of the pin 155 can be substantially co-planar with respect to one another.

In some embodiments, the second member 160 can define the second bore 162 at least partially therethrough. In such embodiment, the second bore 162 and the first bore 161 can partially intersect one another. In such embodiments, the second bore 162 can be configured to receive a wedge (not shown) that can include an engagement surface that can contact an engagement surface of the pin 155, as described above with reference to FIGS. 1-4.

It should be understood that the trunnion body 130 in the mechanical joint 700 can be configured to be connected to and disconnected from the second part 109 of the turntable 105 via the same or substantially the same process as the mechanical joint 100 described above with reference to FIGS. 5 and 6. It should also be understood that, in some embodiments, the second and third bores 137, 139 defined by the second pair of opposing sides of the trunnion body 130 and the pin 155, when connected to one another, can be aligned along the third axis 170. In some embodiments, as shown, the second axis 150 and the third axis 170 can be substantially perpendicular with respect to one another. In other embodiments, not shown, the second axis 150 and the third axis 170 can be substantially orthogonal with respect to one another.

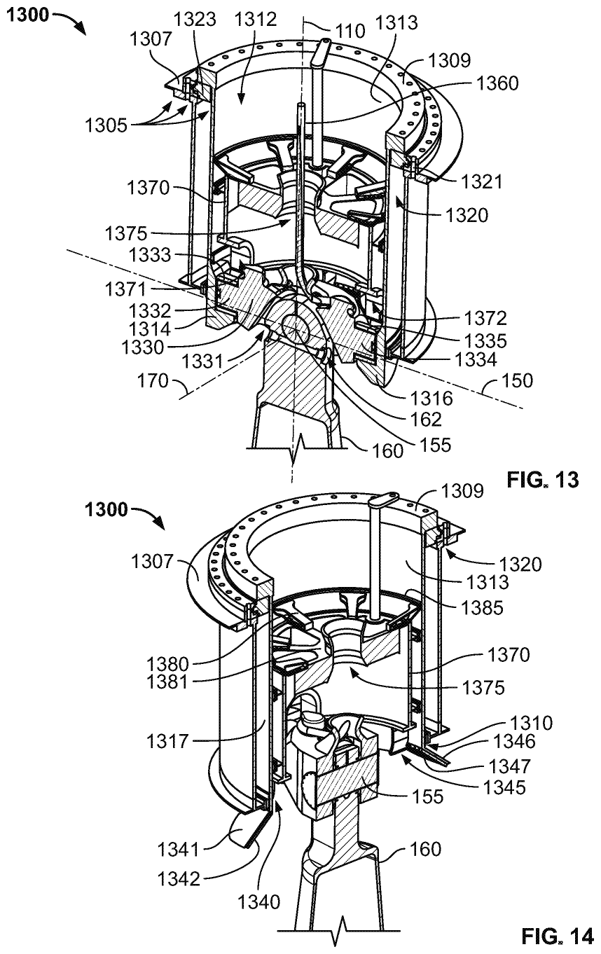

FIG. 13 depicts an isometric cross-sectional view of another illustrative mechanical joint 1300 configured to provide an articulated connection between a first member, e.g., a vessel (see FIG. 23), and a second member 160, according to one or more embodiments. FIG. 14 depicts another isometric cross-sectional view of the mechanical joint 1300 shown in FIG. 13. Continuing with reference to FIGS. 13 and 14, the mechanical joint 1300 can include a turntable 1305 that can include a first part 1307 configured to be fixedly connected to the first member, e.g., a vessel, and a second part 1309 rotatively connected to the first part 1307. The second part 1309 of the turntable 1305 can be configured to rotate about the first axis 110 with respect to the first part 1307. The second part 1309 of the turntable 1305 can define a bore 1312 at least partially therethrough. The second part 1309 of the turntable 1305 can include a first trunnion support 1314 and a second trunnion support 1316 that can extend from opposing sides of an inner surface 1313 of the bore 1312 defined by the second part 1309 of the turntable 1305. The mechanical joint 1300 can also include a bearing 1310 between the first part 1307 and the second part 1309 of the turntable 1305. The bearing 1310 can be the same as or similar to the bearing 710 described above with reference to FIG. 8.

The mechanical joint 1300 can also include a trunnion body 1330 that can include a first trunnion 1332 disposed on and extending from a first side and a second trunnion 1334 disposed on and extending from a second side of the trunnion body 1330, as described above with reference to FIGS. 1-4. The trunnion body 1330 can also define a first bore 1331 at least partially therethrough that can be configured to receive an end of the second member 160, and a second bore and a third bore that can extend from an inner surface of the first bore toward and/or to an exterior surface of the trunnion body 1330 that can be configured to receive the pin 155 to secure the second body 160 to the trunnion body 1330, as described above with reference to FIGS. 1-4. The first and second trunnions 1332, 1334 can be configured to be supported by the first and second trunnion supports 1314, 1316, respectively. When the first and second trunnions 1332, 1334 are supported by the first and second trunnion supports 1314, 1316, the first and second trunnions 1332, 1334 and the first and second trunnion supports 1314, 1316 can be aligned along the second axis 150.

The trunnion body 1330 can be rotatively connected to the second part 1309 of the turntable 1305 when the first and second trunnions 1332 and 1334 are supported by the first and second trunnion supports 1314, 1316. In some embodiments, the second member 160 can define the second bore 162 at least partially therethrough. In such embodiment, the second bore 162 and the first bore 161 can partially intersect one another. In such embodiments, the second bore 162 can be configured to receive a wedge (not shown) that can include an engagement surface that can contact an engagement surface of the pin 155, as described above with reference to FIGS. 1-4.

In some embodiments, the first part 1307 of the turntable 1305 can be fixedly connected to the first member, e.g., a vessel (see FIG. 23), and the second part 1309 of the turntable 1305 can be rotatively connected to the first part 1307 via one or more bearings 1320. As shown, the bearing 1320 can be or can include a three-row roller bearing that can include a first part 1321 that can be connected to or integrated with the first part 1307 of the turntable 1305 and a second part 1323 that can be connected to or integrated with the second part 1309 of the turntable 1305. The bearing 1320 can be configured to support an axial load, a horizontal load, and an overturning moment load. Three-row roller bearings are well-known to those having ordinary skill in the art. Suitable three-row roller bearings can include those described in U.S. Pat. Nos. 10,046,834; 10,183,727; 10,538,291; and 11,319,030. Other suitable bearings that can be used as the bearing 1320 can include those described in U.S. Pat. No. 8,950,349.

It should be understood that the trunnion body 1330 in the mechanical joint 1300 can be configured to be connected to and disconnected from the second part 1309 of the turntable 1305 via the same or substantially the same process as the mechanical joint 100 described above with reference to FIGS. 5 and 6. In some embodiments, the second part 1309 of the turntable 1305 can be rotated with respect to the first part 1307 of the turntable 1305 via one or more drive mechanisms, as described above.

As shown in FIG. 13, a lifting/lowering line 1360 can be connected to the trunnion body 1330 that can be used to raise and lower the trunnion body 1330 into and out of the inner bore 1312 defined by the second part 1309 of the turntable 1305. In some embodiments, the lifting/lowering line can be or can include, but is not limited to, a synthetic rope, a metal or wire rope, a chain, a cable, any other suitable elongated member, or any combination thereof. It should also be understood that, in some embodiments, the second and third bores 137, 139 defined by the second pair of opposing sides of the trunnion body 130 and the pin 155, when connected to one another, can be aligned along the third axis 170. In some embodiments, as shown, the second axis 150 and the third axis 170 can be substantially perpendicular with respect to one another. In other embodiments, not shown, the second axis 150 and the third axis 170 can be substantially orthogonal with respect to one another.

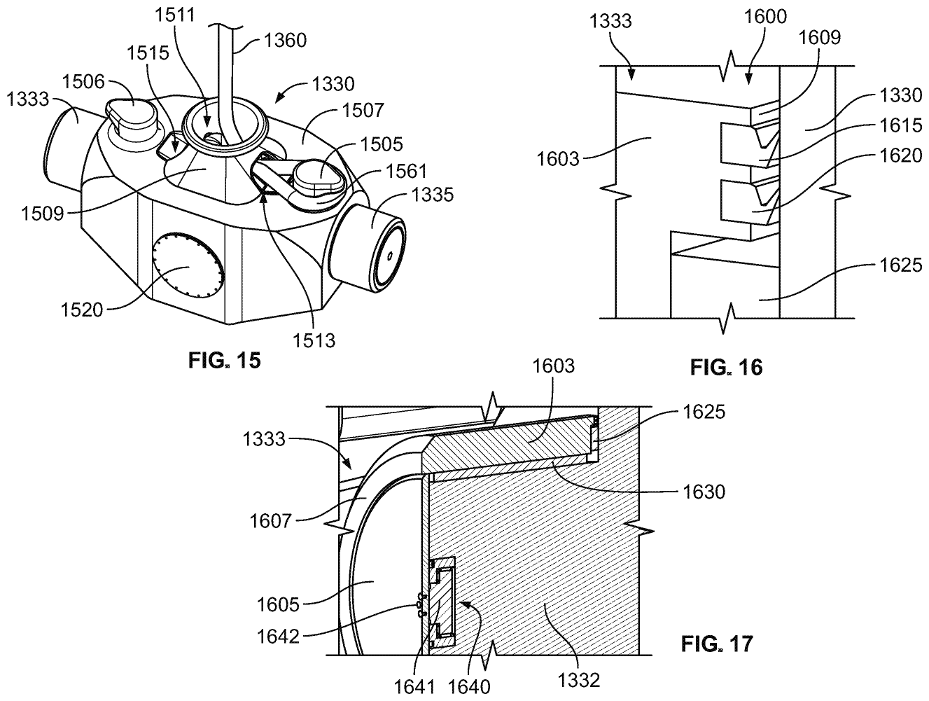

One difference between the mechanical joint 700 and the mechanical joint 1300 is that the mechanical joint 1300 can include a first trunnion cap 1333 disposed about and secured to the first trunnion 1332 and a second trunnion cap 1335 disposed about and secured to the second trunnion 1334. When the first and second trunnions 1332, 1334 are supported by the first and second trunnion supports 1314, 1316, respectively, the first and second trunnions 1332, 1334 can be configured to rotate relative to the first and second trunnion caps 1333, 1335. The trunnion caps 1333, 1335 will be described in more detail below with reference to FIGS. 15-17.

Another difference between the mechanical joint 700 and the mechanical joint 1300 is that the mechanical joint 1300 can include a first trunnion guide channel 1340 and a second trunnion guide channel 1345 (see FIG. 14) that can extend from opposing sides of the inner surface 1313 of the bore 1312 defined by the second part 1309. The first and second trunnion guide channels 1340, 1345 can be configured to guide the first and second trunnions 1332, 1334, respectively, and the trunnion caps 1333, 1335, respectively, disposed thereon into the bore 1312 defined by the second part 1309 and out of the bore 1312 defined by the second part 1309 during connection and disconnection, respectively, of the trunnion body 1330.

In some embodiments, the first and second trunnion guide channels 1340, 1345 can include two opposing walls that can define a channel that can include an open mouth or bottom and an open mouth or top that can permit the trunnions 1332, 1334 to move or otherwise pass therethrough. In some embodiments, the two opposing walls can be substantially parallel with respect to one another. In other embodiments, a section or length of the two opposing walls within the bore 1312 defined by the second part 1309 located toward the bearing 1320 can be substantially parallel with respect to one another and a section or length of the two opposing walls located away from the bearing 1320 can move away from one another to provide a wider channel at the bottom of the first and/or second guide channels 1340, 1345.

In some embodiments, the mechanical joint 1300 can also include a first guide member 1341 that can include a first guide surface 1342 and a second guide member 1346 that can include a second guide surface 1347. The first guide member 1341 can extend from the first trunnion guide channel 1340 and away from an outer surface 1317 of the second part 1309. The second guide member 1346 can extend from the second trunnion guide channel 1345 and away from the outer surface 1317 of the second part 1309. The first and second guide surfaces 1342 and 1347, respectively, can be used to help guide the first and second trunnions 1332, 1334, respectively, and the trunnion caps 1333, 1335, respectively, disposed thereon into the first and second guide channels 1340, 1345, respectively, during connection of the trunnion body 1330 to the first and second trunnion supports 1314, 1316, respectively.

Another difference between the mechanical joint 700 and the mechanical joint 1300 is that the mechanical joint 1300 can include a guide body 1370 disposed within the bore 1312 defined by the second body 1309. In some embodiments, the guide body 1370 can be secured within the inner bore 1312 defined by the second part 1309 of the turntable 1305 via a lower contact surface 2005 (see FIG. 20) and a plurality of upper retainer bodies 1380 that can be connected to an upper surface 1381 of the guide body 1370. An end of the retainer bodies 1380 can contact a lower surface of a retainer ring 1385 such that the guide body 1370 can be secured within the inner bore 1312 of the second body 1309 between the lower contact surface 2005 and a lower edge or side of the retainer ring 1385, as described in more detail below with reference to FIG. 22.

The guide body 1370 can define a bore 1375 therethrough that can allow for the passage of the lifting/lowering line 1360 therethrough. The guide body 1370 can include a first guide slot 1371 and a second guide slot 1372 that can be configured to receive the first and second trunnions 1332, 1334, respectively, and the trunnion caps 1333, 1335, respectively, disposed thereon. In some embodiments, the first and second guide slots 1371, 1372 can define a upside down U-shaped saddle structure that can include an open mouth or bottom. In other embodiments, the first and second guide slots 1371, 1372 can define an upside down semi-circular shaped saddle structure that can include an open mouth or bottom.

The first and second guide slots 1371, 1372 can be configured to receive the first and second trunnions 1332, 1334 and corresponding trunnion caps 1333, 1335 within the U-shaped and/or semi-circular shaped saddle structures. The first and second guide slots 1371, 1372 can be aligned with the first and second guide channels 1340, 1345 when the trunnion body 1330 enters into the bore 1312 defined by the second part 1309 during connection of the trunnion body 1330 to the second part 1309. Likewise, the first and second guide slots 1371, 1372 can be aligned with the first and second guide channels 1340, 1345 when the trunnion body 1330 exits the bore 1312 defined by the second part 1309 during disconnection of the trunnion body 1330 from the second part 1309. The ends of the first and second guide slots 1371, 1372 can act as a stop for the trunnion 1330 when the trunnion body 1330 is moved into the bore 1312 defined by the second body 1309 during a connection sequence and when the trunnion body 1330 is moved away from the first and second trunnion supports 1314, 1316 during a disconnection sequence.

During connection and disconnection of the trunnion body 1330 to and from the second part 1309, the second body 1309 can rotate relative to the first part 1307 of the turntable 1305, as described above with reference to FIGS. 5 and 6. Similarly, during connection and disconnection of the trunnion body 1330 to and from the second part 1309, the second body 1309 can rotate relative to the guide body 1370. Said another way, when the second part 1309 of the turntable 1305 rotates during connection and disconnection of the trunnion body 1330 thereto and therefrom, the first part 1307 of the turntable 1305 and the guide body 1370 can remain in a fixed position relative to one another.

FIG. 15 depicts a close-up isometric view of the trunnion body 1330 that includes the first and second trunnion caps 1333, 1335 disposed on the first and second trunnions 1332, 1334, respectively, according to one or more embodiments. In some embodiments, the lifting/lowering line 1360 can be connected to the trunnion body 1330 via one or more mooring horns or plates 1505, 1506 that can be connected to an upper surface 1507 of the trunnion body 1330. As shown, the upper surface 1507 of the trunnion body 1330 can also include a guide housing 1509 connected to the upper surface 1507 that can define a first bore 1511, a second bore 1513, and optionally a third bore 1515 at least partially therethrough. The first bore 1511 and the second bore 1513 and, if present, the third bore 1515 can be in communication with one another. As shown, an end 1561 of the lifting/lowering line 1360 can include a loop and can be routed through the first bore 1511 and the second bore 1513 and connected to the mooring horn or plate 1505. In some embodiments, a second lifting/lowering line (not shown) can be connected to the trunnion body 1330 by routing an end of the second lifting/lowering line that can include a loop through the first bore 1511 and the third bore 1515 and connected to the mooring horn or plate 1506. It should be understood that other suitable type of connector can be used in lieu of the guide housing 1509 and mooring horns or plates 1505, 1506. For example, a padeye, a clevis, a trunnion, a lifting lug, or the like, can be connected to the upper surface 1507 of the trunnion body 1330 to which one or more lifting/lowering lines 1360 can be connected.

In some embodiments, the trunnion body 1330 can also include caps or plates 1520 (only one is visible) that can be secured thereto that can seal the ends of the pin 155 (see FIGS. 13 and 14). The plate 1520 can be secured to the trunnion body 1330 via one or more fasteners, welding, a threaded connection, or via any other suitable manner. The plates 1520 can prevent water, dust, dirt, mud, or other substances from entering into the trunnion body 1330 between the pin 155 and the inner wall of the bore defined by the trunnion body 1330 that can receive the pin 155 therein.

FIG. 16 depicts a close-up view of an illustrative sealing arrangement 1600 that can be disposed between the ends of the first and second trunnion caps 1333, 1335 and the trunnion body 1330, according to one or more embodiments. FIG. 17 depicts an illustrative connector arrangement 1640 that can be used to connect the first and second trunnion caps 1333, 1335 to the first and second trunnions 1332, 1334, respectively. The first trunnion cap 1333 will be further described but it should be understood the second trunnion cap 1335 can be constructed in the same manner as the first trunnion cap 1333. Continuing with reference to FIGS. 16 and 17, the first trunnion cap 1333 can have a cylindrical body 1603 and an end plate or cap 1605 that can be connected to a first end 1607 of the cylindrical body 1603. The cylindrical body 1603 and the end cap 1605 can be formed from a metal or metal alloy, e.g., steel. In some embodiments, the end cap 1605 can be connected to the cylindrical body 1603 via welding, one or more fasteners, a threaded connection, or via any other suitable manner. In some embodiments, the first end 1607 of the cylindrical body 1603 can be chamfered or can include another sloped surface.

In some embodiments, the sealing arrangement 1600 can include one or more seals (two are shown, 1615 and 1620) that can be disposed between the trunnion body 1330 and a second end 1609 of the cylindrical body 1603. The seals 1615, 1620 can prevent water, dirt, mud, or other substances from entering into the region located between the first trunnion cap 1333 and the first trunnion 1332.

In some embodiments, a washer 1625 can be located about the first trunnion 1332 between the second end 1609 of the first trunnion cap 1333 and the trunnion body 1330. In some embodiments, a bushing 1630 can be located between the first trunnion cap 1333 and the first trunnion 1332. In some embodiments, the washer 1625 and the bushing 1630 can be composed of a self-lubricated composite material. In some embodiments, the washer 1625 can be secured to the second end 1609 of the first trunnion cap 1333. In some embodiments, the bushing 1630 can be secured to the first trunnion 1332. As such, the bushing 1630 can move with the trunnion body 1330 and the first trunnion 1332 relative to the first trunnion cap 1333. In some embodiments, the washer 1625 and/or the bushing 1630 can be secured to the trunnion body 1330 and the first trunnion 1332 via bonding, press fitting, freeze fitting, or any combination thereof.

The first trunnion cap 1333 can be secured to the first trunnion 1332 via the connector arrangement 1640. As shown, the connector arrangement 1640 can include a “mushroom” type body 1641 that can be secured to an inner surface of the end cap 1605 via one or more fasteners 1642. A retainer body 1645 can be secured to the end of the trunnion 1332 that can retain the body 1641. When the retainer body 1645 secures the body 1641 to the first trunnion 1332, the first trunnion cap 1333 can be rotatably secured to the first trunnion 1332. As such, when the trunnion body 1330 and first trunnion 1332 rotate relative to the first trunnion cap 1333, the bushing 1630 can rotate with the trunnion body 1330 and the first trunnion 1332 and the washer 1625 can remain fixed to the trunnion cap 1333.

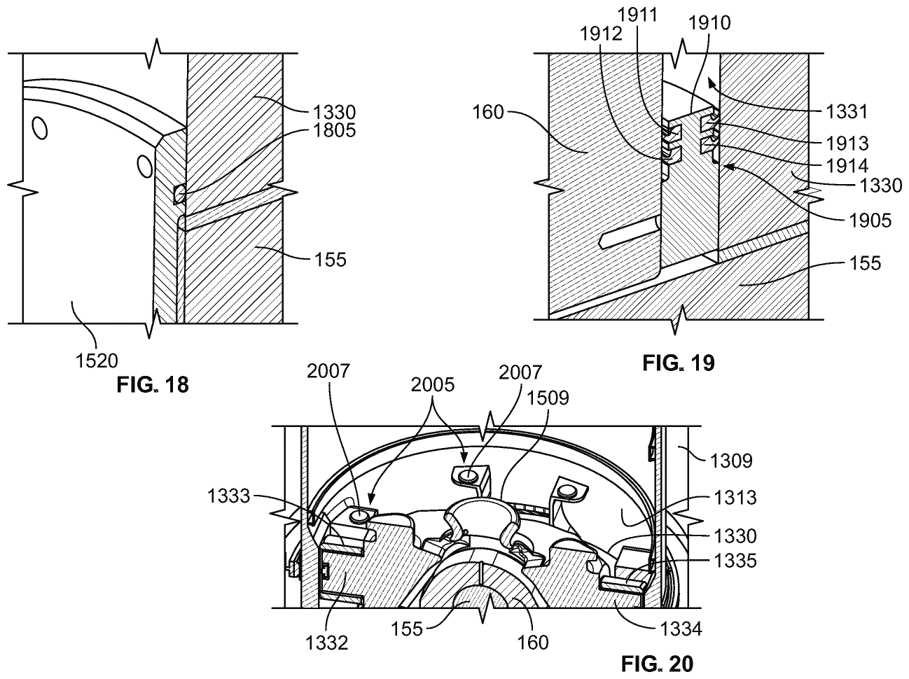

FIG. 18 depicts a close-up cross-sectional view of the plate 1520 connected to the trunnion body 1330, according to one or more embodiments. As shown, one or more seals 1805 can be located between an inner surface of the plate 1520 and an exterior surface of the trunnion body 1330. In some embodiments, the seal 1805 can be an o-ring, as shown. In other embodiments, the seal 1805 can be in the form of a washer or any other suitable form. The seal 1805 can prevent water, dust, dirt, mud, or other substances from entering into the trunnion body 1330 between the pin 155 and the inner wall of the bore defined by the trunnion body 1330.

FIG. 19 depicts a close-up cross-sectional view of a sealing arrangement 1905 that be located between an inner surface of the bore 1331 defined by the trunnion body 1330 and the second member 160 connected thereto, according to one or more embodiments. In some embodiments, the sealing arrangement 1905 can include a seal retaining body 1910 that can be configured to retain one or more seals. As shown, the seal retaining body 1910 can be configured to retain a first seal 1911 and a second seal 1912 between the seal retaining body 1910 and the second member 160 and a first seal 1913 and a second seal 1914 between the seal retaining body 1910 and the trunnion body 1330. The sealing arrangement 1905 can prevent water, dust, dirt, mud, or other substances from entering into the region between the pin 155 and the bores defined by the second member 160 and the trunnion body 1330 that receive the pin 155 to secure the second member 160 to the trunnion body 1330.

FIG. 20 depicts an isometric cross-sectional view showing a lower contact surface 2005 for the guide body 1370 (see FIGS. 13 and 14) that can be disposed within the mechanical joint 1300, according to one or more embodiments. The lower contact surface 2005 can be secured to and extend from the inner surface 1313 of the second part 1309 of the turntable 1305. The lower surface of the guide body 1370 can be supported by the lower contact surface 2005. In some embodiments, the lower contact surface 2005 can include contact pads 2007 that can facilitate rotation of the second part 1309 of the turntable 1305 relative to the lower surface of the guide body 1370. In some embodiments, the contact pads can be composed of a self-lubricated composite material.

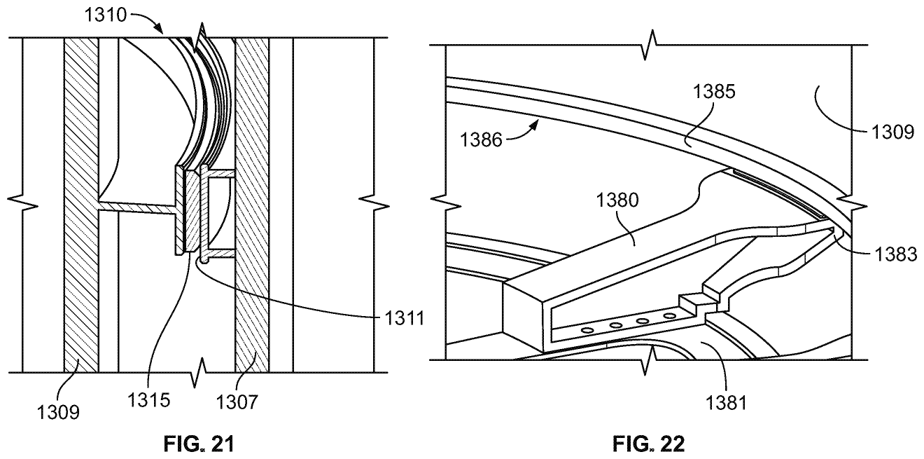

FIG. 21 depicts a close-up cross-sectional view of the bearing 1310 shown in FIGS. 13 and 14, according to one or more embodiments. As shown, the bearing 1310 can include a first contact surface 1311 that can be disposed on the first part 1307 of the turntable 1305 and a second contact surface 1315 that can be disposed on the second part 109 of the turntable 1305. The first contact surface 1311 and the second contact surface 1315 can be configured to engage with one another and the second contact surface 1315 can be configured to move with respect to the first contact surface 1311.

In some embodiments, the first contact surface 1311 can be composed of a metal or metal alloy, e.g., stainless steel, and the second contact surface 1315 can be composed of a self-lubricated composite material. In other embodiments, the first contact surface 1311 can be composed of a self-lubricated composite material and the second contact surface 1315 can be composed of a metal or metal alloy, e.g., stainless steel. In still other embodiments, the first contact surface 1311 and the second contact surface 1315 can each be composed of a self-lubricated composite material.

FIG. 22 depicts a close-up view of an upper retainer body 1380 that can be configured to secure the guide body 1370 against the lower contact surface 2005 depicted in FIG. 20, according to one or more embodiments. The upper retainer body 1380 can be secured to the upper surface 1381 of the guide body 1370 via one or more fasteners, welding, or any other suitable connector. An end 1383 of the retainer body 1380 can be in contact with a lower edge or surface 1386 of the retainer ring 1385. As such, the retainer bodies 1380, when secured to the upper surface 1381 of the guide body 1370, can prevent the guide body 1370 from moving away from the lower contact surface 2005.

FIG. 23 depicts an isometric view of an illustrative mooring system 2300 for mooring a vessel 2301 floating on a surface 2302 of a body of water 2303 that can include the mechanical joints 100 and/or 700 and/or 1300 described above with reference to FIGS. 1-6, FIGS. 7-12, and FIGS. 13-22, respectively, according to one or more embodiments. In some embodiments, the mooring system 2300 can include a base structure 2304 configured to be secured to or disposed on a seabed 2305 below the surface 2302 of the body of water 2303. In some embodiments, the base structure 2304 can be fixed or secured to the seabed 2305 with driven piles or suction piles 2306, as shown. More particularly, as shown, the base structure 2304 can include one or more pile sleeves 2339 that can be disposed about the one or more piles 2306 to fix or secure the base structure 2304 to the seabed 2305. In other embodiments, the base structure 2304 can be a gravity-based structure (not shown). The particular manner in which the base structure 2304 can be disposed on the seabed 2305 can be based, at least in part, on the seabed conditions at the site and/or expected loading forces transmitted thereto when the vessel 2301 is moored to the base structure 2304 via the mooring system 2300. It should be understood that when the base structure 2304 is a gravity-based structure, in some embodiments, the base structure 2304 can maintain an acceptable orientation with respect to the seabed 2305 without requiring the base structure 2304 to include driven piles, suction piles, or the like that can be physically connected to the seabed 2305.

The mooring system 2300 can also include a turntable 2307 that can be configured to be rotatively connected to the base structure 2304. The turntable 2307 can be configured to rotate about a vertical or a substantially vertical axis 2308 with respect to the base structure 2304. The mooring system 2300 can also include a yoke structure or simply “yoke” 2309 that can have a first end 2310 and a second end 2311. The yoke 2309 can be a fabricated, e.g., steel, structure. In some embodiments, the first end 2310 of the yoke 2309 can be configured to connect to the turntable 2307 in a manner that can permit the yoke 2309 to at least partially rotate about a longitudinal axis or roll axis 2312 of the yoke 2309. In some embodiments, the yoke 2309 can also be configured to connect to the turntable 2307 in a manner that can permit the yoke 2309 to at least partially rotate or pivot about a second axis or pitch axis 2313 that can be orthogonal or perpendicular or substantially orthogonal or perpendicular to the longitudinal axis 2312 of the yoke 2309. In some embodiments, the second axis 2313 can be within +/−10 degrees, +/−5 degrees, +/−3 degrees, or +/−1 degree of being orthogonal or perpendicular to the longitudinal axis 2312 of the yoke 2309.

In some embodiments, the connection between the first end 2310 of the yoke 2309 and the turntable 2307 can include a roll bearing, a bushing, or the like 2314. In some embodiments, the roll bearing, bushing, or the like 2314 can be disposed on the first end 2310 of the yoke 2309 (as shown) or on the turntable 2307 or between the first end 2310 and the second end 2311 of the yoke 2309 in other embodiments. In some embodiments, the longitudinal axis 2312 of the yoke 2309 can be horizontal or substantially horizontal, e.g., within +/−10 degrees, +/−5 degrees, +/−3 degrees, or +/−1 degree, with respect to a horizontal plane when the vessel 2301 is connected to the turntable 2307 via the mooring system 2300 and is in a neutral or static position with respect to the base structure 2304. In some embodiments, the rotative or pivotable connection between the first end 2310 of the yoke 2309 and the turntable 2307 can include at least one pitch bearing or trunnion arrangement (not visible).

In some embodiments, the yoke 2309 can include a ballast tank, a weight, or a combination thereof 2316 that can be connected toward or at the second end 2311 of the yoke 2309. For simplicity and ease of description a ballast tank will be further used to describe the system, but the use of the term “ballast tank” can be replaced with the term “weight” or a combination of the terms “ballast tank and a weight”. Additionally, the mooring system 2300 will be further described as including the ballast tank 2316. However, it should be understood that the ballast tank 2316 can be an optional component and, as such, not included in some embodiments. The ballast tank 2316 can be configured to contain a ballast material. The ballast tank 2316 can also be a fabricated, e.g., steel, structure. In some embodiments, the yoke 2309 that includes the ballast tank 2316 can be disposed below the surface 2302 of the body of water 2303. The ballast material can have a specific gravity that is greater than that of the body of water 2303. Examples of ballast material can be or can include, but are not limited to, concrete, sand, aggregate, iron ore, magnetite, rocks, drilling mud, any other material that has a specific gravity greater than that of the water, or any combination or mixture thereof. The weight, if present, can be a body having a fixed mass, e.g., a solid metal body.

The mooring system 2300 can also include at least one link arm (two are shown, 2317, 2318) that can be configured to connect the second end 2311 of the yoke 2309, e.g., via the ballast tank 2316, to the vessel 2301. In some embodiments, a single link arm can include two arms each having a first end connected to the ballast tank 2316 or the second end 2311 of the yoke 2309 where the first end of each arm converges at the second end thereof such that the single link arm can include a single connector configured to connect to the vessel 2301. In other embodiments, the mooring system 2300 can include three, four, or more link arms that can be configured to connect the ballast tank 2316 or the second end 2311 of the yoke 2309 to the vessel 2301.

In some embodiments, the link arms 2317, 2318 can be or can include one or more elongated rigid structures, one or more chains, one or more cables, or any other suitable elongated member, or any combination thereof. In some embodiments, a first end 2319, 2320 of each link arm 2317, 2318 can be configured to connect to the ballast tank 2316 or the second end 3111 of the yoke 2309 via a coupler 2321, 2322, respectively. In some embodiments, the couplers 2321, 2322 can be or can include, but are not limited to, universal joints, ball and socket joints, flexible joints that can include a plurality of steel and rubber spherical layers laminated together to provide rotational articulation about two non-parallel axes disposed at each end thereof, a padeye, a tri-plate, or any other suitable coupler. A second end 2323, 2324 of each link arm 237, 238 can be configured to connect to the vessel 2301 via the mechanical joint 100 and/or 700 and/or 1300. In some embodiments, the link arms 2317, 2318 can be connected to the ballast tank 2316 or the second end 2311 of the yoke 2309 via the same type of coupler or via different types of couplers. An illustrative commercially available flex joint can include the FLEXJOINT® available from Oil States Industries.

In some embodiments, the mooring system 2300, when mooring the vessel 2301 to the base structure 2304 can be at least partially submerged. For example, the base structure 2304, the turntable 2307, the yoke 2309, the ballast tank 2316, and a portion of the link arms 2317, 2318 can be located below the surface 2302 of the water 2303 and a portion of the link arms 2317, 2318 can be located above the surface 2302 of the water 2303 when the vessel 2301 is moored to the base structure 2304 of the mooring system 2300. When the mooring system 2300 is disconnected from the vessel 2301, the link arms 2317, 2318 can also be located below the surface 2302 of the water 2303. In another example, the base structure 2304, the turntable 2307, the yoke 2309, the ballast tank 2316, the link arms 2317, 2318, and a first component of the mechanical joints 100 and/or 700 and/or 1300 can be located below the surface 2302 of the water 2303 when the vessel 2301 is disconnected from the mooring system 2300.

As noted above, in some embodiments, the mooring system 2300 can also include the mechanical joints 100 and/or 700 and/or 1300 that can connect the link arms 2317, 2318 to the vessel 2301. In some embodiments, the mooring system 2300 can include one, two, three, four, or more of the mechanical joints 100 and/or 700 and/or 1300, with the number of mechanical joints 100 and/or 700 corresponding to the number of link arms.

In some embodiments, the mooring system 2300 can also include one or more fluid swivels 2329 that can include a rotating part disposed on the turntable 2307 and fixed part disposed on the base structure 2304. The fluid swivel 2329 can include a fixed part disposed on the base structure 2304, e.g., within a housing 2330 of the base structure 2304, that can be coupled to a rotating part 2331 disposed on the turntable 2307. The fluid swivel 2329 can be configured to provide unlimited rotative fluid connectivity between one or more fluid paths therethrough. In such embodiment, one or more fluid conduits (one is shown, 2332) configured to transfer one or more fluids from the fluid swivel 2329 to the vessel 2301 and/or from the vessel 2301 to the fluid swivel 2329 can be connected between the vessel 2301 and the rotating part 2331 of the fluid swivel 2329. The fixed part of the fluid swivel 2329 can be in fluid communication with a subsea pipeline or pipeline end manifold 2338.

In some embodiments, the fluid swivel 2329 can include a single fluid flow path or can include two, three, four, or more fluid flow paths therethrough. When the fluid swivel 2329 includes two or more fluid flow paths therethrough, the two or more fluid flow paths can be configured to remain segregated from one another. In some embodiments, when the fluid swivel 2329 includes two or more flow paths therethrough, the two or more flow paths can be configured to transfer a fluid from the rotating part 2331 of the fluid swivel 2329 to the vessel 2301 or from the vessel 2301 to the rotating part 2331 of the fluid swivel 2329. In other embodiments, when the fluid swivel 2329 includes two or more flow paths therethrough, at least one fluid flow path can be configured to transfer a fluid from the rotating part 2331 of the fluid swivel 2329 to the vessel 2301 and at least one fluid flow path can be configured to transfer a fluid from the vessel 2301 to the rotating part 2331 of the fluid swivel 2329.

In some embodiments, the vessel 2301 can include a riser porch system 2333 disposed on the vessel 2301. The riser porch system 2333 can be configured to fluidly connect the fluid conduit 2332 to one or more storage tanks or other storage structures disposed on and/or within the vessel 2301. The fluid conduit 2332 can be a flexible pipe, a series of rigid pipes connected together with a plurality of swivel joints, a flexible hose, or any combination thereof. In some embodiments, the fluid conduit 2332 can be configured in a wave or catenary configuration and can be supported at one or more locations that can be selected from the turntable 2307, the yoke 2309, the ballast tank 2316, the link arms 2317, 2318, and/or the vessel 2301. As shown, the fluid conduit 2332 can be supported by one or more ballast tank bending shoes 2336 and/or one or more turntable bending shoes 2337.

In some embodiments, the fluid conduit 2332 can include a quick disconnect/quick connect fitting on an end of the fluid conduit connected to the vessel 2301 to permit relatively fast connection and disconnection or reconnection of the fluid conduit 2332 to and from the vessel 2301. In other embodiments, the fluid conduit 2332 can have a quick disconnect/quick connect fitting on an end connected to the rotating part 2331 of the fluid swivel 2329. In such embodiment, the fluid conduit 2332 connected to the rotating part 2331 of the fluid swivel 2329 can be retrieved from the body of water 2303 and taken with the vessel 2301 upon disconnection of the vessel 2301 from the mooring system 2300. In still other embodiments, the fluid conduit 2332 can include a quick disconnect/quick connect fitting disposed between the first and second ends thereof such that a portion of the fluid conduit 2332 can remain in the body of water 2303 and a portion of the fluid conduit 2332 can be retrieved onto the vessel 2301 and taken with the vessel 2301 upon disconnection of the vessel 2301 from the mooring system 2300.

The mooring system 2300 can also include a first lifting device 2334 and a second lifting device 2335. The lifting devices 2334, 2335 can independently be or include, but are not limited to, a lifting device that utilizes a linear moving mechanism, a rotary torque mechanism, or a combination thereof. Suitable lifting devices that utilize a linear moving mechanism can be or can include, but are not limited to, chain jacks, strand jacks, linear winches, or the like. Suitable lifting devices that utilize a rotary torque mechanism can be or can include, but are not limited to, rotary winches that include one or more drums, e.g., single drum rotary winches or two drum rotary winches, a powered windlass, or the like. The windlass typically includes a chain wheel that includes, e.g., seven pockets, that can grip a chain, but the chain does not roll up on a drum but instead is moved off or onto the chain wheel as the chain is pulled in or let out. The lifting devices that utilize the linear moving mechanism can be powered via an internal combustion engine-hydraulic power unit or an electric hydraulic power unit. The lifting devices that utilize the rotary torque mechanism can be powered via electricity, hydraulics, an internal combustion engine, or combination thereof.

In some embodiments, the lifting devices 2334, 2335 can be configured such that a speed at which the lifting devices 2334, 2335 operate at can be tuned, adjusted, or otherwise correlated to account for a motion of the vessel that can be caused by wind, waves, swell, and/or current present at a given mooring location. In some embodiments, the lifting devices 2334, 2335 can be configured such that a speed at which the lifting devices 2334, 2335 operate at is not tuned, adjusted, or otherwise correlated to account for a motion of the vessel. Said another way, the lifting devices 2334, 2335 can be configured to lift and lower the first and second link arms 2317, 2318 and the yoke 2309 and the ballast tank 2316 at a speed that is independent from a motion of the vessel 2301.

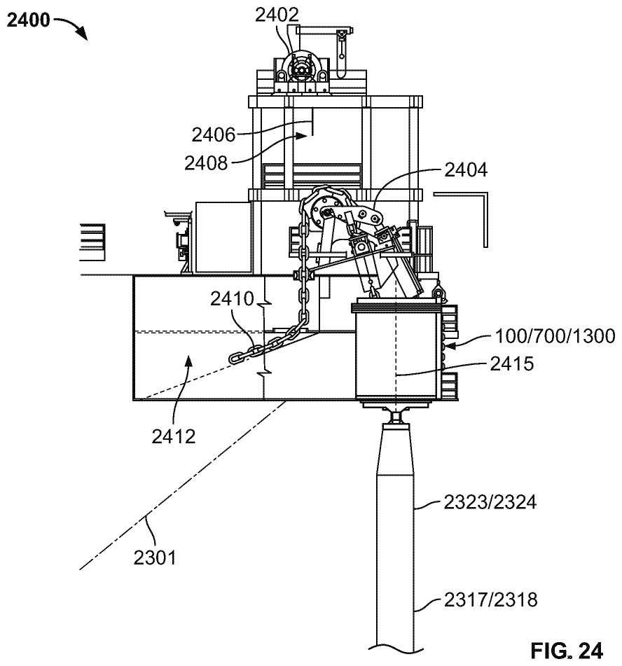

FIG. 24 depict a side elevation partial cross-sectional view of an illustrative lifting arrangement 2400 that includes a first lifting device 2402 and second lifting device 2404 that can be used to connect and disconnect the mechanical joint 100 shown in FIGS. 1-6 and/or the mechanical joint 700 shown in FIGS. 7-12, and/or the mechanical joint shown in FIGS. 13-22, according to one or more embodiments. In some embodiments, the lifting arrangement 2400 can be disposed on a bow or a stern of the vessel 2301. In some embodiments, the first and the second lifting devices 2402, 2404 can be configured to lift the first and second link arms 2317, 2318 (see FIG. 23), respectively, along with the yoke 2309 and the ballast tank 2316 from a position where the yoke 2309 and the ballast tank 2316 are resting on the seabed 2305 or a landing structure, e.g., a mud mat or fenders located on the seabed 2305, to a position at which the ballast tank 2316 and the link arms 2317, 2318 can be suspended from the vessel 2301 via connection with the mechanical joints 100 and/or 700. The first and second lifting devices 2402, 2404 can also be configured to lower one of the link arms 2317, 2318 along with the yoke 2309 and the ballast tank 2316 from the suspended position to a position where the yoke 2309, the ballast tank 2316, and the link arms 2317, 2318 are resting on the seabed 2305 or resting on the optional landing structure.

In some embodiments, the first lifting device 2402 can include a rotary winch 2402 and a chain jack 2404 that can be configured to lift and lower the first link arm 2317 and at least a portion of the yoke 2309 and the ballast tank 2316. Another or second lifting arrangement 2400 can also be configured to lift and lower the second link arm 2318 and at least a portion of the yoke 2309 and the ballast tank 2316. In some embodiments, the first two lifting devices, i.e., the first and second rotary winches 2402, of the first and second lifting arrangements 2400 can be configured to lift or lower the link arms 2317, 2318 and the second two lifting devices, i.e., the first and second chain jacks 2404, of the first and second lifting arrangement 2400 can be configured to lift or lower the yoke 2309 and the ballast tank 2316 along with the link arms 2317, 2318.

The mooring system 2300 can also include at least one lifting/lowering line. In some embodiments, the lifting/lowering line can include two segments coupled together. More particularly, a first segment 2406 can be connected at a second end to the rotary winch 2402 and a first end 2408 thereof to a second end of a second segment 2410 when the first segment 2406 pulls in the second segment 2410 via the rotary winch 2402 into engagement with the chain jack 2404. As shown, the second segment 2410 has engaged the chain jack 2404 and, as such, the first end 2408 of the first segment 2406 has been disconnected therefrom to allow the second segment 2404 to be conveyed into a storage compartment 2412 configured to receive the second segment 2410. When the lifting arrangement 2400 includes the chain jack 2404, the second segment 2410 can be a chain. A first end of the second segment 2406 can be configured to be connected to the second ends 2323, 2324 of the link arms 2317, 2318 and/or the mechanical joints 100 and/or 700 and/or 1300 that can be connected to the second ends 2323, 2324 of the link arms 2317, 2318. In other embodiments, when the lifting arrangement 2400 includes a strand jack or a linear winch, the second segment 2410 can be a cable, a wire, or the like.

As shown in FIG. 24, the chain jack 2404 and the rotary winch 2402 are offset from a central longitudinal axis 2415 extending from the mechanical joint 100, 700, and/or 1300. In other embodiments, however, the chain jack 2404 and/or the rotary winch 2402 or at least the first segment 2406 and the second segment 2410 can be substantially aligned with the central longitudinal axis 2424 extending from the mechanical joint 100, 700, and/or 1300 such that the lifting arrangements 2400 can be configured to raise and lower the second ends 2323, 2324 of the link arms 2317, 2318 and/or the mechanical joints 100 and/or 700 and/or 1300 in a direction that can be substantially aligned with the central longitudinal axis 2415.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation can be permitted.

While certain preferred embodiments of the present invention have been illustrated and described in detail above, it can be apparent that modifications and adaptations thereof will occur to those having ordinary skill in the art. It should be, therefore, expressly understood that such modifications and adaptations may be devised without departing from the basic scope thereof, and the scope thereof can be determined by the claims that follow.

What is claimed is:

1. A mechanical joint configured to provide an articulated connection between a first member and a second member, comprising:
a turntable comprising a first part configured to be fixedly connected to the first member and a second part rotatively connected to the first part, wherein:
the second part is configured to rotate about a first axis with respect to the first part,
the second part defines a bore at least partially therethrough, and
a first trunnion support and a second trunnion support extend from opposing sides of an inner surface of the bore defined by the second part; and
a trunnion body that defines a first bore at least partially therethrough, wherein:
the trunnion body comprises a first trunnion disposed on and extending from a first exterior side and a second trunnion disposed on and extending from a second exterior side of a first pair of opposing sides of the trunnion body,
the first and second trunnions are aligned along a second axis and configured to be supported by the first and second trunnion supports, respectively,
a first side of a second pair of opposing sides of the trunnion body defines a second bore extending from an inner surface of the first bore to an exterior of the first side of the second pair of opposing sides,
a second side of the second pair of opposing sides of the trunnion body defines a third bore extending from the inner surface of the first bore at least partially through and toward an exterior of the second side of the second pair of opposing sides,
the second bore and the third bore defined by the second pair of opposing sides of the trunnion body are aligned along a third axis,
the second axis and the third axis are substantially orthogonal or substantially perpendicular with respect to one another,
the second bore and the third bore defined by the second pair of opposing sides is configured to receive a pin, and
the pin is configured to connect the second member to the trunnion body such that when the second member is connected to the trunnion body and the first and second trunnions are supported by the first and second trunnion supports, the second member is configured to at least partially rotate about the first, second, and third axes.

2. The mechanical joint of claim 1, wherein the first trunnion support and the second trunnion support are each configured as U-shaped saddle structures comprising an open mouth such that the first and second trunnions are supported within the U-shaped saddle structures of the first and second trunnion supports, respectively.

3. The mechanical joint of claim 2, wherein the trunnion body is configured to be disconnected from the second part of the turntable by:
moving the trunnion body away from the first and second trunnion supports such that the first and second trunnions are moved out of the U-shaped saddle structures of the first and second trunnion supports, respectively, and
rotating the second part of the turntable with respect to the first part of the turntable sufficiently such that the trunnion body can be moved toward and past the U-shaped saddle structures of the first and second trunnion supports.

4. The mechanical joint of claim 3, wherein the second part of the turntable is configured to be rotated about 70 degrees to about 110 degrees with respect to the first part of the turntable.

5. The mechanical joint of claim 1, wherein the first part and the second part of the turntable are rotatively connected via a first bearing and a second bearing, and wherein the first bearing and the second bearing are longitudinally displaced with respect to one another along the first axis.

6. The mechanical joint of claim 5, wherein the first bearing is a three-row roller bearing configured to handle an axial load, a horizontal load, and an overturning moment load, and wherein the second bearing is a plain bearing configured to handle a horizontal load.

7. The mechanical joint of claim 5, wherein the second and third axes and the second bearing are substantially co-planar with respect to one another.

8. The mechanical joint of claim 1, wherein:
the pin is configured to be disposed through a first bore defined by the second member,
opposing ends of the pin are configured to be received by the second bore and the third bore defined by the second pair of opposing sides, respectively, to connect the second member to the trunnion body,
the second member further defines a second bore at least partially therethrough,
the first bore and the second bore defined by the second member partially intersect one another, and
when the pin is disposed through the first bore defined by the second member, a wedge can be configured to be disposed within the second bore defined by the second member such that an engagement surface formed on a portion of an external surface of the wedge can contact an engagement surface formed on a portion of an external surface of the pin.

9. The mechanical joint of claim 8, wherein, when the wedge engages with the pin, relative movement between the pin and the second member is reduced as compared to when the wedge is not engaged with the pin.

10. The mechanical joint of claim 1, further comprising a first bushing disposed between the first trunnion and the first trunnion support and a second bushing disposed between the second trunnion and the second trunnion support.

11. The mechanical joint of claim 1, further comprising a guide body disposed within the bore defined by the second body, wherein the guide body comprises a first guide slot configured to receive the first trunnion and a second guide slot configured to receive the second trunnion, respectively, during connection and disconnection of the trunnion body to the second part of the turntable.

12. The mechanical joint of claim 11, wherein, during connection and disconnection of the trunnion body, the second part of the turntable is configured to rotate relative to the trunnion body, the guide body, and the first part of the turntable.

13. The mechanical joint of claim 1, further comprising a first trunnion guide channel and a second trunnion guide channel extending from opposing sides of the inner surface of the bore defined by the second part, wherein the first and second trunnion guide channels are configured to guide the first and second trunnions, respectively, into the bore defined by the second part and out of the bore defined by the second part during connection and disconnection, respectively, of the trunnion body.

14. The mechanical joint of claim 13, further comprising a first guide surface extending from the first trunnion guide channel and away from an outer surface of the second part and a second guide surface extending from the second trunnion guide channel and away from the outer surface of the second part.

15. The mechanical joint of claim 1, further comprising a first trunnion cap disposed about and secured to the first trunnion and a second trunnion cap disposed about and secured to the second trunnion, wherein, when the first and second trunnions are supported by the first and second trunnion supports, respectively, the first and second trunnions are configured to rotate relative to the first and second trunnion caps.

16. The mechanical joint of claim 1, wherein the trunnion body comprises a guide housing and a mooring plate disposed on an upper surface of the trunnion body, wherein the guide housing defines a first bore at least partially therethrough and a second bore at least partially therethrough, wherein the first bore and the second bore defined by the guide housing are in communication with one another and configured to pass a first end of a lifting/lowering line therethrough such that the first end of the lifting/lowering line can be routed through the first and second bores defined by the guide body and connected to the mooring plate.

17. The mechanical joint of claim 1, wherein the first member is a vessel floating on a surface of a body of water and the second member is a link arm configured to connect the vessel to a submerged yoke.

18. The mechanical joint of claim 17, wherein the link arm is configured to be connected to a ballast tank connected to the submerged yoke.

19. A disconnectable yoke mooring system for mooring a vessel floating on a surface of a body of water, comprising:
a base structure configured to be disposed on a seabed;
a first turntable configured to be connected to the base structure such that the turntable is rotatable with respect to the base structure about a vertical axis;
a yoke comprising a first end and a second end, wherein the first end of the yoke is configured to be connected to the turntable in a manner permitting the yoke to at least partially rotate about a longitudinal axis of the yoke and to at least partially rotate about a second axis that is substantially orthogonal or substantially perpendicular to the longitudinal axis of the yoke;
a first link arm and a second link arm each having a first end configured to be connected to the second end of the yoke;
a first mechanical joint and a second mechanical joint each configured to connect a second end the first and second link arms, respectively, to the vessel, the first and second mechanical joints each comprising:
a second turntable comprising a first part configured to be fixedly connected to the vessel and a second part rotatively connected to the first part, wherein:
the second part is configured to rotate about a first axis with respect to the first part,
the second part defines a bore at least partially therethrough, and
a first trunnion support and a second trunnion support extend from opposing sides of an inner surface of the bore defined by the second part; and
a trunnion body that defines a first bore at least partially therethrough, wherein:
the trunnion body comprises a first trunnion disposed on and extending from a first exterior side and a second trunnion disposed on and extending from a second exterior side of a first pair of opposing sides of the trunnion body,
the first and second trunnions are aligned along a second axis and configured to be supported by the first and second trunnion supports, respectively,
a first side of a second pair of opposing sides of the trunnion body defines a second bore extending from an inner surface of the first bore to an exterior of the first side of the second pair of opposing sides,
a second side of the second pair of opposing sides of the trunnion body defines a third bore extending from the inner surface of the first bore at least partially through and toward an exterior of the second side of the second pair of opposing sides,
the second bore and the third bore defined by the second pair of opposing sides of the trunnion body are aligned along a third axis,
the second axis and the third axis are substantially orthogonal or substantially perpendicular with respect to one another,
the second bore and the third bore defined by the second pair of opposing sides is configured to receive a pin, and
the pin of the first mechanical joint is configured to connect the second end of the first link arm and the pin of the second mechanical joint is configured to connect the second end of the second link arm, respectively, to the trunnion body such that when the first and second link arms are connected to the vessel, the first and second link arms are configured to at least partially rotate about the first, second, and third axes;
a first lifting/lowering line and a second lifting/lowering line each having a first end configured to be connected to the second ends of the first link arm and the second link arm, respectively; and
a first lifting device and a second lifting device each configured to be disposed on the vessel, wherein the first lifting device and the second lifting device are configured to be connected to a second end of the first lifting/lowering line and a second end of the second lifting/lowering line, respectively, wherein, when the first and second lifting devices are disposed on the vessel and connected to the second ends of the first and second lifting/lowering lines, respectively, and the first end of the first and second lifting/lowering lines are connected to the second ends of the first and second link arms, respectively, the first and second lifting devices are configured to lift and lower the first and second link arms and the yoke.

20. A process for disconnecting a first member from a second member that are connected to one another via a mechanical joint, comprising:
moving the second member and a trunnion body relative to the first member such that a first trunnion and a second trunnion are both separated and clear from a first trunnion support and a second trunnion support, respectively, wherein the mechanical joint comprises:
a turntable comprising a first part fixedly connected to the first member and a second part rotatively connected to the first part, wherein:
the second part is rotatable about a first axis with respect to the first part,
the second part defines a bore at least partially therethrough, and
the first trunnion support and the second trunnion support extend from opposing sides of an inner surface of the bore defined by the second part; and
the trunnion body defines a first bore at least partially therethrough,
the trunnion body comprises the first trunnion disposed on and extending from a first exterior side and the second trunnion disposed on and extending from a second exterior side of a first pair of opposing sides of the trunnion body,
the first and second trunnions are aligned along a second axis and supported by the first and second trunnion supports, respectively, prior to moving the second member and the trunnion body relative to the first member,
a first side of a second pair of opposing sides of the trunnion body defines a second bore extending from an inner surface of the first bore to an exterior of the first side of the second pair of opposing sides,
a second side of the second pair of opposing sides of the trunnion body defines a third bore extending from the inner surface of the first bore at least partially through and toward an exterior of the second side of the second pair of opposing sides,
the second bore and the third bore defined by the second pair of opposing sides of the trunnion body are aligned along a third axis,
the second axis and the third axis are substantially orthogonal or substantially perpendicular with respect to one another,
a pin is disposed through a bore defined by the second member and at least partially within the second bore and the third bore defined by the second pair of opposing sides that connects the second member to the trunnion body, and
the second member is at least partially rotatable about the first, second, and third axes;
rotating the second part of the turntable relative to the first part of the turntable such that the first trunnion and second trunnion are clear of the first trunnion support and the second trunnion support when viewed along the first axis; and
moving the second member and the trunnion body such that the trunnion body moves past the first trunnion support and the second trunnion support when viewed along the first axis.
